(19) United States
(12) Patent Application Publication
(10) Pub. No.: US 2009/0160095 A1
(43) Pub. Date: Jun. 25, 2009

(54) Biodegradable thermoplasticized starch-polyester reactive blends for thermoforming applications

(75) Inventors: Ramani Narayan, Okemos, MI (US); Jacqueline Stagner, Berkley, MI (US); Vanessa Dias Alves, Sao Paulo (BR)

Correspondence Address: Ian C. McLeod;IAN C. McLEOD, P.C., 2190 Commons Parkway, Okemos, MI, 48864, US

(73) Assignee: Board of Trustees of Michigan State University, East Lansing, MI (US)

(21) Appl. No.: 12/315,583

(22) Filed: Dec. 4, 2008

Related U.S. Application Data
(63) Continuation-in-part of application No. 10/993,186, filed on Nov. 19, 2004.
(60) Provisional application No. 61/005,483, filed on Dec. 5, 2007.

(51) Int. Cl. B29C 51/02; C08B 30/00; C08K 5/053

(52) U.S. Cl. 264/331.21; 525/54.24; 524/386

(57) ABSTRACT

The disclosure relates to a starch-polyester graft copolymer, for example formed by the reactive blending of a thermoplastic starch (TpS) and/or a modified thermoplastic starch (MTpS) with a biodegradable polyester. The thermoplastic starch includes starch (e.g., a high-amylose starch) and a plasticizer, and can further include a chemical modifier and an optional initiator. The graft copolymer preferably is completely (or substantially completely) biodegradable, for example based on the biodegradability of each of its components. The graft copolymer can be formed into sheets of material that can be subsequently thermoformed, for example into single-use, disposable articles.

### CROSS REFERENCE TO RELATED APPLICATIONS

Priority to U.S. Provisional Application Ser. No. 61/005,483, filed Dec. 5, 2007, which is incorporated herein by reference in its entirety, is claimed.

This application is a continuation-in-part of U.S. patent application Ser. No. 10/993,186, filed Nov. 19, 2004, which is incorporated herein by reference in its entirety.

### BACKGROUND OF THE DISCLOSURE

1. Field of the Disclosure

The present disclosure relates to the reactive blending of thermoplasticized starch (e.g., in the form of thermoplastic starch (TpS) and/or modified thermoplastic starch (MTpS; for example modified with maleic acid) with a biodegradable polyester (e.g., poly(butylene adipate-co-terephthalate)), to produce sheets of material that can be thermoformed. Single-use disposable items are typically thermoformed; making such disposable, thermoformed items biodegradable would be environmentally responsible.

2. Brief Description of Related Technology

Starch, the storage polysaccharide of cereals, legumes and tubers, is a renewable and widely available raw material suitable for a variety of industrial uses. Corn is the primary source of starch, although considerable amounts of starch are produced from cassava, potato, wheat, and rice. Starch has been considered for many years as a polymer with a high potential for packaging applications because of its low cost, renewability, and biodegradability.

As a packaging material, starch alone does not form films with adequate mechanical properties (high percentage of elongation, tensile, and flexural strength).¹ Starch by itself is unsuitable because disadvantages such as: a) brittleness in the absence of plasticizers, b) hydrophilic nature and poor water resistance, c) deterioration of mechanical properties upon exposure to environmental conditions like humidity, and d) soft and weak nature in the presence of plasticizers.²

Starch is not a thermoplastic material, but in the presence of a plasticizer (e.g., water, glycerol, sorbitol), high temperatures (e.g., 90-180° C.), and shear, the starch loses its semi-crystalline granular structure and acquires thermoplastic behavior, allowing its use in injection molding, and in cast- and blown-film resin compositions.

Thermoplastic starch (TpS) has weaknesses that limit its utilization in packaging applications, and particularly for thermoforming applications. These weaknesses are especially problematic due to the low wall thickness of the produced objects.³ Major drawbacks are water sensitivity⁴, change of mechanical properties with time⁵, crystallization due to aging, water adsorption, and low impact strength resistance.

Starch granules exhibit hydrophilic properties and strong inter-molecular association via hydrogen bonding due to the hydroxyl groups on the granule surface. The hydrophilicity and thermal sensitivity render the starch polymer unsuitable for thermoplastic applications. In this respect, some authors have emphasized on finding the optimal polymer or mixture of polymers and other admixtures in order to thereby “optimize” the properties of the starch. One drawback is that most of the polymers and other admixtures are themselves significantly more expensive than starch, which tends to increase the cost of such polymer blends compared to starch melts. Another drawback is that such additives will only be able to marginally alter the mechanical properties of the starch/polymer blends when viewed from a materials science perspective.

Examples of patents that disclose the manufacture of starch and blends of starch and other polymers include U.S. Pat. Nos. 5,095,054, 4,673,438, 5,256,711, 5,275,774, 5,382,611, and 5,405,564. There have been business reports of the use of thermoplastic starch as a component in multi phase blends.⁶⁻¹⁰ Still others have manufactured thermoplastic starch blends in which native starch is initially blended with a small quantity of water and a less volatile plasticizer such as glycerin in order to form starch melts that are subjected to a degassing procedure prior to cooling and solidification in order to remove substantially all of the water therefrom. Examples of such patents include U.S. Pat. Nos. 5,280,055, 5,288,765, 5,262,458, 5,412,005, 5,462,980, and 5,512,378.

Blends of thermoplastic starch (TpS) with biodegradable polyesters can improve the mechanical properties and decrease the water sensitivity of the TpS. Commercial biodegradable polyesters have high cost (3.5 to 5.0 euro/kg), so blending starch with biodegradable polyesters is a price reduction strategy. Polymer blends containing varying amounts of starch have been studied extensively as possible replacements for plastics, mainly in the area of packaging as films or injection molded materials.

Graft copolymerization of a vinyl monomer onto the starch backbone has been used to modify starch. Some applications of starch-graft copolymers include starch blended with poly (ethylene-co-acrylic acid) (EAA).¹¹⁻¹⁵ In these papers, the authors suggested the formation of hydrogen bonds between the carboxylic group in EAA and the hydroxyl group in starch. Increasing the level of starch decreased the percentage elongation of the film and increased the diffusion rate of water. Similar complexes like EAA can also be formed with the hydroxyl groups of the polyethylene-vinyl alcohol (EVOH) copolymer. They report a reaction between the anhydride group in the synthetic polymer with the hydroxyl (—OH) groups of starch. U.S. Pat. No. 5,462,983 reports on blends and alloys containing lignocelluloses like starch, cellulose acetate, etc. U.S. Pat. No. 5,314,934 provides a process to produce a polyolefin-starch polymer blend. Ethylene/acrylate/maleic anhydride terpolymer was used as a compatibilizer. These blends were reported to be blown into film with properties comparable to LDPE. U.S. Pat. No. 5,234,977 discloses a material used for the production of biodegradable articles in film, sheet or fiber form, which can be produced by extrusion from a molten mass that includes a synthetic thermoplastic polymer and a destructured starch to which a boron containing compound such as boric acid has been added. U.S. Pat. No. 6,277,899 discloses a polymeric composition comprising filler melt-dispersed in a matrix comprising a destructurized starch component, a synthetic thermoplastic polymeric component, and a fluidizing agent. U.S. Pat. No. 5,412,005 discloses biodegradable polymeric compositions containing a starch-based component and a polymeric component, preferably polymers of ethylene-vinyl alcohol or polyvinylalcohol.

Other publications related to modified starches/polysaccharides and/or starch-polyester blends include U.S. Pat. Nos. 5,500,465, 5,540,929, 5,578,691, 5,616,671, 5,869,647, 6,235,816 and 6,472,497.

High levels of starch and its poor compatibility with biodegradable polyesters lead to poor physical and mechanical properties. An effective way to improve the compatibility between starch and the polyester matrix is to functionalize the polyester matrix by grafting highly reactive functional groups. Synthetic polymers that have been reactively blended with starch have the following functional groups, carbonyl, anhydride, epoxy, urethane, or oxazoline that can react with the hydroxyl or carbonyl groups in native and modified starches.²

Maleic anhydride (MA) has been grafted onto many different hydrophobic polymers, both biodegradable¹⁶⁻²³ and non-biodegradable²⁴⁻²⁵, to produce functional polymers that are then blended with thermoplastic starch (TpS). Thus, the maleated polymers can act as compatibilizers between the non-functional polymer and the starch.

### Objects

There is a need for a starch-polyester graft copolymer that has sufficient mechanical properties for use as a thermoformed article (preferably disposable), yet that also has favorable biodegradability properties. These and other objects may become increasing apparent by reference to the following description and drawings.

### SUMMARY

The disclosure relates to a starch-polyester graft copolymer, for example formed by the reactive blending of a thermoplastic starch (TpS) and/or a modified thermoplastic starch (MTpS) with a biodegradable polyester. The thermoplastic starch includes starch (e.g., a high-amylose starch) and a plasticizer, and can further include a chemical modifier and an optional initiator. The graft copolymer preferably is completely (or substantially completely) biodegradable, for example based on the biodegradability of each of its components. The graft copolymer can be formed into sheets of material that can be subsequently thermoformed, for example into single-use, disposable articles.

In one embodiment, a starch-polyester graft copolymer composition comprises: (a) a thermoplastic starch, the thermoplastic starch comprising a high-amylose starch (e.g., at least about 40 wt. % amylose) and a plasticizer (e.g., a polyhydric alcohol), and (b) segments of a biodegradable polyester grafted onto the thermoplastic starch, for example including a reactively extruded a mixture of the thermoplastic starch and the biodegradable polyester with heating and venting of water from the mixture. The starch-polyester graft copolymer is preferably completely biodegradable. The high-amylose starch can include one or more starches such as corn, potato, wheat, rice, sago, tapioca, waxy maize, sorghum, and cassava starch. The thermoplastic starch preferably comprises a modified thermoplastic starch, the modified thermoplastic starch comprising a reactively blended mixture of the starch, the plasticizer, a chemical modifier comprising one or more dibasic acids, cyclic anhydrides thereof, or combinations thereof (e.g., maleic acid, succinic acid, itaconic acid, phthalic acid, and anhydrides thereof), and an optional free radical initiator. Suitable biodegradable polyester include one or more biodegradable aliphatic polyesters, biodegradable aliphatic-aromatic polyesters, and poly(β-hydroxyalkanoates). Additional biodegradable polyesters include those with one or more repeating units according to Formulas I-III:

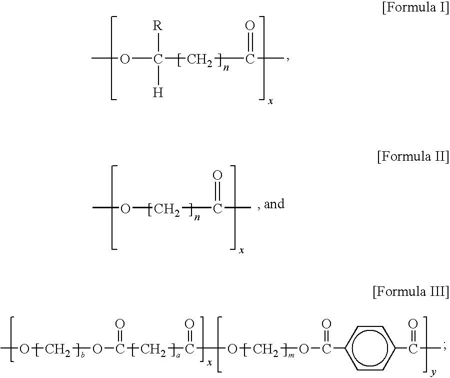

wherein: (i) in Formula I, R comprises one or more lower alkyl and aromatic groups containing 1 to 12 carbon atoms, and n ranges from 0 to 10; (ii) in Formula II, n ranges from 0 to 10; and (iii) in Formula III, a, b and m range from 2 to 8, and x/y ranges from about 3/2 to 10/1.

In another embodiment, a starch-polyester graft copolymer composition comprises: (a) a modified thermoplastic starch, the modified thermoplastic starch comprising a reactively blended mixture of a high-amylose starch, a polyhydric alcohol plasticizer, a chemical modifier comprising one or more dibasic acids, cyclic anhydrides thereof, or combinations thereof, and an optional free radical initiator; and (b) segments of a biodegradable aliphatic-aromatic polyester grafted onto the modified thermoplastic starch. In a refinement, the thermoplastic starch comprises about 65 wt. % to about 85 wt. % of the high-amylose starch and about 20 wt. % to about 40 wt. % of the polyhydric alcohol plasticizer, both relative to the thermoplastic starch weight; and the starch-polyester graft copolymer comprises about 40 wt. % to about 70 wt. % of the thermoplastic starch and about 30 wt. % to about 60 wt. % of biodegradable aliphatic-aromatic polyester, both relative to the starch-polyester graft copolymer weight. In another refinement, the high-amylose starch comprises a corn starch having an amylose content of at least about 65 wt. %; the chemical modifier comprises one or more of maleic acid and maleic anhydride; the polyhydric alcohol plasticizer comprises glycerol; and the reactively blended mixture comprises the free radical initiator. The biodegradable aliphatic-aromatic polyester can include repeating units according to Formula III:

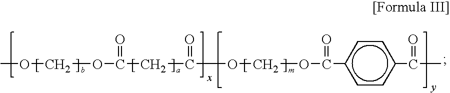

wherein a, b and m range from 2 to 8, and x/y ranges from about 3/2 to 10/1.

Also disclosed is a process for the preparation of a starch-polyester graft copolymer according to any of the foregoing embodiments and a thermoformed article made therefrom. The process comprises: melt extruding a mixture of (a) a thermoplastic starch, the thermoplastic starch comprising a starch and a plasticizer and (b) a biodegradable polyester at a temperature that grafts segments of the biodegradable polyester onto the thermoplastic starch, thereby forming a starch-polyester graft copolymer sheet; and thermoforming the starch-polyester graft copolymer sheet (e.g., about 0.1 mm to about 5 mm thick), thereby forming a thermoformed article (e.g., cups, containers, lids, trays). Preferably, the thermoplastic starch comprises a modified thermoplastic starch, the modified thermoplastic starch being formed by reactively blending or extruding (e.g., at a temperature ranging from about 90° C. to about 180° C.) a mixture of the starch, the plasticizer, a chemical modifier comprising one or more dibasic acids, cyclic anhydrides thereof, or combinations thereof, and an optional free radical initiator. The melt-extruded mixture is preferably heated and vented during extrusion to release water and any unreacted chemical modifier. From the mixture.

As an alternative to the modification of hydrophobic polymers by grafting maleic anhydride onto the polymer, a starch/polymer (biodegradable or non-biodegradable) system can be compatibilized by instead modifying the starch. Narayan et al. U.S. Pat. No. 7,153,354, incorporated by reference herein in its entirely, provides a modified starch by reacting the starch with an organic dibasic acid or an anhydride in the presence of plasticizer, using a free radical initiator, thereby producing a chemically modified plasticized starch. The disclosure relates to biodegradable, reactive, chemically modified, plasticized starch compositions with low viscosity and good processability. An important aspect of the disclosure is that the process uses no added water, and prevents problems such as high viscosity, clogging of the thermoplastic starch melt at the die, and foaming of the thermoplastic starch melt. Furthermore, the resulting chemically modified plasticized starch composition is highly reactive to yield graft copolymers with polyesters. The starch-polyester graft copolymers are readily processable into films and molded into products using conventional plastics processing equipment. The resultant product has balanced in mechanical properties, water resistance, processability, and rate of biodegradation.

All patents, patent applications, government publications, government regulations, and literature references cited in this specification are hereby incorporated herein by reference in their entirety. In case of conflict, the present description, including definitions, will control.

Additional features of the disclosure may become apparent to those skilled in the art from a review of the following detailed description, taken in conjunction with the drawings, examples, and appended claims.

### BRIEF DESCRIPTION OF THE DRAWINGS

For a more complete understanding of the disclosure, reference should be made to the following detailed description and accompanying drawings wherein:

FIG. 1 is a diagram of an extrusion apparatus for the production of polyester grafted starch.

FIGS. 2a, 2b and 2c are drawings depicting the screw configuration used for the reactive extrusion production of the novel graft copolymers. The screw configuration is divided into three sections (FIG. 2A followed by FIG. 2B and further followed by FIG. 2C).

FIG. 3 is a graph showing the FTIR results of graft copolymers of ECOFLEX, (poly (butylene adipate-co-terephthalate)), obtained from BASF (Germany), with plasticized starch (PS). To validate the reactivity, FTIR scans of pure ECOFLEX, PS and ECOFLEX/PS blend (without the catalyst) are also shown.

FIG. 4 is a graph showing the FTIR results of graft copolymers of ECOFLEX with CMPS (made using both maleic anhydride and maleic acid modifiers). To validate the reactivity, FTIR scans of pure ECOFLEX and regular cornstarch are also shown.

FIG. 5 shows bar graphs depicting tensile strength values of ECOFLEX, graft copolymer of ECOFLEX with CMPS, graft copolymer of cross-linked ECOFLEX with CMPS, graft copolymer of ECOFLEX with PS and LDPE.

FIG. 6 shows bar graphs depicting modulus of elasticity values of ECOFLEX, graft copolymer of ECOFLEX with CMPS, graft copolymer of cross-linked ECOFLEX with CMPS, graft copolymer of ECOFLEX with PS and LDPE.

FIG. 7 shows bar graphs depicting break elongation values of ECOFLEX, graft copolymer of ECOFLEX with CMPS, graft copolymer of cross-linked ECOFLEX with CMPS, graft copolymer of ECOFLEX with PS and LDPE.

FIG. 8 illustrates the FTIR spectra for (1) HA starch, (2) PBAT, and (3) a MTpS (165° C., 2% MA, 0.1% L101, 20% G)-PBAT blend (50:50).

FIG. 9 illustrates the FTIR spectra of MTpS (165° C., 2% MA, 0.1% L101, 20% G)-PBAT blends (60:40) for (1) as-extruded pellets, (2) pellets remaining after soxhlet extraction in dichloromethane, and (3) a film produced when the solvent from the soxhlet extract was evaporated.

FIGS. 10-12 illustrate the tensile strength (MPa), the Young's modulus (MPa), and the elongation (%) of Examples 9-16.

FIGS. 13a-13c are environmental scanning electron microscopy images for Examples 9-11 extruded at 165° C.

FIGS. 14a-14d are environmental scanning electron microscopy images for Examples 12-15 extruded at 135° C.

While the disclosed compositions and methods are susceptible of embodiments in various forms, specific embodiments of the disclosure are illustrated in the drawings (and will hereafter be described) with the understanding that the disclosure is intended to be illustrative, and is not intended to limit the claims to the specific embodiments described and illustrated herein.

### DETAILED DESCRIPTION

The present disclosure relates to starch-polyester graft copolymer composition that includes (a) a thermoplastic starch, and (b) segments of a biodegradable polyester grafted onto the thermoplastic starch. The thermoplastic starch includes starch (preferably a high-amylose starch) and a plasticizer, and can further include a chemical modifier and an optional initiator. The thermoplastic starch can be formed by extruding a mixture of the starch, plasticizer, and any optional chemical modifier/initiator. Preferably, the graft copolymer is a reactively extruded a mixture of the thermoplastic starch and the biodegradable polyester with heating and venting of water (e.g., residual water present in the thermoplastic starch) from the mixture. Preferably, the graft copolymer is completely (or substantially completely) biodegradable, for example based on the biodegradability of each of its components. The graft copolymer can be formed as sheets of material that can be subsequently thermoformed, for example into single-use, disposable articles.

It is believed that the mechanism of reaction is that fragments of a biodegradable polyester resin from the processing react with hydroxyl groups of the starch, thereby forming an amphiphilic starch-polyester graft copolymer. When present, the chemical modifier (e.g., dibasic acid acid or anhydride thereof) reacts with the polyester to produce the reactive fragments. Thus, the starch-polyester graft copolymer is a unique composition with the fragments of the polyester bonded to the starch.

### Thermoplastic Starch

The thermoplastic starch can include various types of starches, native or modified. Such starches include those derived from any plant source including corn, potato, wheat, rice, sago, tapioca, waxy maize, sorghum, cassava. Starch ((C₆H₁₀O₅)ₙ) is a mixture of linear (amylose) and branched (amylopectin) polymers. Amylose is essentially a linear polymer of α(1→4) linked D-glucopyranosyl units. Amylopectin is a highly-branched polymer of D-glucopyranosyl units containing α(1→4) linkages with α(1→6) linkages at the branch points. The starch can include regular corn starch, which contains about 75 wt. % amylopectin (higher molecular weight branched starch polymer) and about 25 wt. % amylose (lower molecular weight linear starch polymer). High amylose starch (e.g., high amylose corn starch) also can be used. High amylose starch has an increased amount of amylose relative to amylopectin, such as a starch having at least about 40 wt. % amylose content (or at least about 50 wt. %, at least about 65 wt. %), for example about 50 wt. % to about 95 wt. % or about 60 wt. % to about 90 wt. %. Compositions having increased levels of linear starch polymers (amylose) can have improved processability, film forming, molding, and mechanical properties. Pulverized starches and/or starch flours can also be used as a starch source. Blends of two or more of the starch starting materials may be used as well as additives or synthetic compounds to improve properties such as water resistance, strength, flexibility, color, etc.

Modified starches also can be used. Modified starches include any of the former starch bases derivatized or modified by processes such as esterification, etherification, maleation, oxidation, acid hydrolysis, crosslinking and enzyme conversion. Typically, modified starches include esters, such as the acetate and half-esters of dicarboxylic acids, particularly the alkenylsuccinic acids; ethers, such as the hydroxyethyl and hydroxypropyl starches and cationic starches such as starch modified with 2-diethylaminoethyl chloride (DEC) and starch modified with quaternary ammonium reagents such as 3-chloro-2-hydroxypropyltrimethylammonium chloride; starches oxidized with hypochlorite or other oxidants; fluidity or thin boiling starches (e.g., 0 to 95 degree of fluidity) prepared by enzyme conversion or mild acid hydrolysis; dextrin prepared by hydrolytic actions of acid and/or heat; starches reacted with crosslinking agents such as phosphorus oxychloride, epichlorohydrin, and phosphate derivatives prepared by reaction with sodium or potassium orthophosphate or tripolyphosphate and combinations thereof.

The thermoplastic starch can include about 40 wt. % to about 95 wt. % starch, for example about 50 wt. % to about 90 wt. % or about 65 wt. % to about 85 wt. %. The thermoplastic starch can be included in the graft copolymer composition at a level of about 30 wt. % to about 70 wt. %, for example about 40 wt. % to about 70 wt. %, about 45 wt. % to about 55 wt. %, or about 50 wt. %. The starch, prior to incorporation into the thermoplastic starch, preferably is free from added water, but can include a (natural) water content of about 0.1 wt. % to about 25 wt. % or about 0.5 wt. % to about 15 wt. %, for example about 0.5 wt. % to about 5 wt. %, about 5 wt. % to about 15 wt. %, or about 5 wt. % to about 25 wt. % water.

A plasticizer is added to the thermoplastic starch to achieve greater material processability and product flexibility, although plasticizers typically soften the compositions in which they are included. Suitable plasticizers include polyhydric alcohols, for example glycerol, sorbitol, ethylene glycol, and mixtures thereof. Glycerol is a suitable plasticizer, since it induces high flexibility, is virtually odorless, has a relatively high boiling point, is biodegradable, and is commercially available at a reasonable cost. The plasticizer concentration in the thermoplastic starch can be about 15 wt. % to about 50 wt. %, about 20 wt. % to about 40 wt. %, or about 25 wt. % to about 40 wt. %, for example about 20 wt. % to about 25 wt. %, about 25 wt. % to about 35 wt. %, or about 25 wt. % to about 30 wt. %.

In an embodiment, the thermoplastic starch is a modified thermoplastic starch that includes, in addition to the starch and plasticizer components, a chemical modifier and (optionally) an initiator. The modified thermoplastic starch is a reactively blended (e.g., via extrusion) so that the chemical modifier reacts with starch hydroxyl groups to provide a reaction product having means for the subsequent grafting of the biodegradable polyester to the thermoplastic starch.

Suitable chemical modifiers provide a chemically modified starch ester product. The starch ester product may preferentially be formed by reaction of the starch hydroxyl groups with chemical modifiers such as dibasic acids, cyclic anhydrides thereof, or combinations thereof to obtain ester linkages with pendant carboxylic groups, thus functioning as a trans-esterification catalyst. The anhydrides can suitably hydrolyze in situ with water present in the starch upon mixing with the starch to form the modified thermoplastic starch. The derived pendant carboxylic group can also catalyze the aforementioned reaction between the hydroxyl groups on the starch, and the dibasic acids or their cyclic anhydrides. Suitable dibasic acids and their cyclic anhydrides include maleic-, succinic-, itaconic-, and phthalic-acids, anhydrides, and combinations thereof. The anhydride or hydrolyzed acid chemical modifier is usually added in the form of a fine powder and is co-extruded with the biodegradable polyester by adding it directly to the extruder. When using maleated starches, maleic anhydride already present in the system functions as a catalyst and hence there is no need to add further chemical modifiers. The modifier is preferably present in amount of about 0.1 wt. % to about 10 wt. % of the thermoplastic starch (e.g., about 0.5 wt. % to about 4 wt. %) and also provides an acidic environment for the mixture.

Optionally, a free radical initiator may be used when forming the modified thermoplastic starch to improve the melt-strength of the modified thermoplastic starch product. Any free radical initiator generally known in the art is appropriate, with thermal initiators that generate free radicals upon heating being preferred. Examples include, but are not limited to, organic peroxides, such as a benzoyl peroxide, di-t-butylperoxide, 2,5-dimethyl-2,5-di (t-butylperoxide) hexane, bis-(o-methylbenzoyl)peroxide, bis(m-methylbenzoyl)peroxide, bis(p-methylbenzoyl) peroxide, or similar monomethylbenzoyl peroxides, bis(2,4-dimethylbenzoyl) peroxide, or a similar dimethylbenzoyl peroxide, dicumylperoxide, t-butyl 3-isopropenylcumyl peroxide, butyl 4,4-bis(tert-butylperoxy)valerate, bis(2,4,6-trimethylbenzoyl)peroxide, or a similar trimethyl-benzoyl peroxide, tert-butylperoctoate, tert-butylperoxypivalate, 1,1-bis(tert-butylperoxy)-3,3,5-trimethylcyclohexane, bis(tert-butylperoxy-isopropyl)benzene, and combinations thereof. Azo compounds, such as azobisisobutyronitrile, also can be used. The free radical initiator is preferably present in an amount ranging from about 0.01 wt. % to about 2 wt. % of the modified thermoplastic starch.

### Biodegradable Polymer

The biodegradable polyester can generally include any ester polymers (or ester copolymers) that substantially (or completely) degrade upon extended exposure to environmental conditions. Suitable biodegradable polyesters include aliphatic polyesters (e.g., poly(caprolactone) (PCL)), and aliphatic-aromatic polyesters (e.g., poly(butylene adipate-co-terephthalate) (PBAT)). Other biodegradable polyesters can include poly(vinylacetate-co-vinylalcohol) (PVAc/VA), poly(lactic acid) or polylactide (PLA), poly(glycolic acid) or polyglycolide (PGA), poly(β-hydroxyalkanoates) (PHA) (e.g., poly(β-hydroxybutyrate) (PHB), poly(β-hydroxybutyrate-co-β-hydroxyvalerate) (PHB/V)), poly(butylene succinate adipate) (PBSA), poly(butylene styrene) (PBS), and related polyesters/copolyesters (e.g., including the various combinations of stereoisomers, bacterial polymers, synthetic polymers, and combinations of the different polyesters). PBAT, a chemo-synthetic biodegradable aliphatic-aromatic copolyester under the brand name ECOFLEX (available from BASF), is made by condensing 1,4-butanediol with 1,4-benzenedicarboxylic acid (i.e., terephthalic acid) and hexanedioic acid (i.e., adipic acid). The biodegradable polyester can be included in the graft copolymer composition at a level of about 30 wt. % to about 70 wt. %, for example about 30 wt. % to about 60 wt. %, about 45 wt. % to about 55 wt. %, or about 50 wt. %.

Accordingly, the biodegradable polyesters can be represented by polymers containing any of the following repeating units:

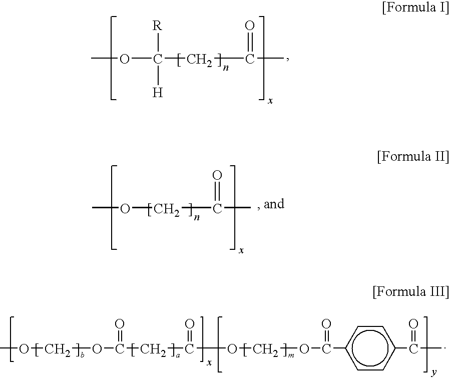

In Formula I, R preferably includes lower alkyl and aromatic groups containing 1 to 12 carbon atoms, and n preferably is 0 to 10 (e.g., 1 to 10). In Formula II, n preferably is 0 to 10 (e.g., 1 to 10). In polymers consisting essentially of repeating units of Formula I and/or II, x preferably ranges from about 200 to 2000. In Formula III, a, b and m preferably are 2 to 8, and x/y preferably ranges from about 3/2 to 10/1.

### Nanoclay

The starch-polyester graft copolymer composition additionally can be in the form of a composite that further includes a nanoclay material, for example a nanoclay that is included in the extrusion mixture used to form the thermoplastic starch (i.e., starch, plasticizer, optional chemical modifiers/initiators).

The nanoclay can be a natural and/or an organically modified nanoclay. Nanoclays can be useful to provide an increased mechanical strength, flame retardancy, gas barrier properties, and improved barrier to water vapor. Suitable nanoclays include smectite, hectorite clays including phyllosilicates such as smectite clay minerals, e.g., montmorillonite, particularly sodium montmorillonite; bentonite; hectorite; saponite; stevensite; beidellite; and the like. The clays used are typically smectite clays, particularly bentonite and hectorite. Smectite clays possess some structural characteristics similar to the better-known minerals talc and mica. Nanoclays can be included in an amount ranging from about 0.5 wt. % to about 25 wt. % of the total composite material.

### Process

The starch-polyester graft copolymer generally can be formed by melt extruding a mixture of (a) the thermoplastic starch (or modified thermoplastic starch) and (b) a biodegradable polyester at a temperature that grafts segments of the biodegradable polyester onto the thermoplastic starch, thereby forming the graft copolymer. The mixture is generally heated and vented as is passes through the extruder, thereby releasing water (e.g., water naturally present in the starch) and any unreacted chemical modifier (e.g., organic dibasic acid or anhydride thereof). Preferably, the graft copolymer is extruded in the form of a sheet that is suitable for subsequent thermoforming into an article (e.g., cup, container, lid, tray), for example a disposable thermoformed article.

The apparatus used in carrying out the extrusion process(es) (i.e., melt extrusion of the components forming the thermoplastic starch or melt extrusion of the thermoplastic starch and the biodegradable polyester) can be any type of extruder, for example a screw type extruder or an extruder having modifications in accordance with conventional design practices. While the use of a single or twin screw extruder can be used, it is preferred to use a twin-screw extruder. Such extruders will typically have rotating screws in a horizontal cylindrical barrel with an entry port mounted over one end and a shaping die mounted at the discharge end. When twin screws are used, they may be co-rotating and intermeshing or non-intermeshing. Each screw will comprise a helical flight or threaded sections and typically will have a relatively deep feed section followed by a tapered transition section and a comparatively shallow constant-depth meter section. The motor-driven screws, generally fit snugly into the cylinder or barrel to allow mixing, heat and shear the material as it passes through the extruder.

Control of the temperature along the length of the extruder barrel is important and is accomplished in zones along the length of the screw. A heat exchange means, typically a passage such as a channel, chamber or bore located in the barrel wall, for circulating a heated media such as oil, or an electrical heater such as calrod or coil type heaters, are often used. Additionally, a heat exchange means may also be placed in or along the shaft of the screw device.

In carrying out the extrusion process, temperatures in the extruder vary depending on the particular material, desired properties and application. The extrusion temperatures can generally range from about 80° C. to about 250° C. or about 100° C. to about 250° C., for example when melt blending the components of the thermoplastic starch or when forming the graft copolymer. Extrusion temperatures for melt blending the thermoplastic starch components can range from about 80° C. to about 180° C., for example from about 100° C. to about 170° C., about 110° C. to about 145° C., or about 125° C. to about 140° C. A extruder is generally operated with a distribution of temperature set-points along its length, so the foregoing temperature ranges can apply to the maximum extrusion temperature and/or the temperature distribution along the substantial extent of the extruder (e.g., because the extruder feed zone may be unheated, having a temperature set-point at about room temperature or 25° C.). The total moisture content of the material in the extruder (i.e., moisture present in the inlet feed starch as well as water in the aqueous anhydride and/or acid) is about 25 wt. % or less, based on the weight of starch. More particularly, the total moisture content can range from about 8 wt. % to 25 wt. %, for example about 10 wt. % to 21 wt. % or about 15 wt. % to 21 wt. %.

The starch-polyester graft copolymers can be manufactured in a one-step process (e.g., in a single extruder). For example, the thermoplastic starch is formed in a first, upstream section of the extruder by mixing the starch and plasticizer, and the biodegradable polyester is mixed with the thermoplastic starch in a second, downstream section of the extruder to form the graft copolymer. Any chemical modifier (e.g., maleic anhydride) and initiator can be added at either the first or second section of the extruder, but the additional components are preferably added in the first section, thereby forming the modified thermoplastic starch prior to mixing with the biodegradable polyester. Alternatively, the starch-polyester graft copolymers can be manufactured in a two-step process. For example, the two-step process can include extrusion forming of the thermoplastic starch in a first extrusion step (which can optionally include pelletization of the thermoplastic starch), followed by extrusion mixing of the thermoplastic starch and the biodegradable polyester in a second extrusion step to form the graft copolymer.

By utilizing the starch-polyester graft copolymer, the overall processing temperature can be reduced to well below the processing temperature of the pure polyester component. This is particularly important for manufacturing with high-melting polyesters (e.g., PHB and PHB/V) that thermally degrade at higher processing temperatures and therefore have a narrower processing window. This improvement is attributed to the compatibility achieved by the reactive blending process, resulting in changes in the crystalline microstructure of the polyester component and/or the morphology of the multi-phase material thereby rendering it processable at lower processing temperatures. It is important that the compounds be compatible.

The disclosed compositions can retain their biodegradability as a whole when using a biodegradable polyester polymer. The water resistance of the thermoplastic starch and modified thermoplastic starch is improved by graft copolymerization with high molecular weight biodegradable polyesters, especially with semi-crystalline polyesters such as PCL or PHB/V, and similar biodegradable polyesters. This is further achieved by engineering the appropriate blend composition, through the choice of polyester, starch and plasticizer.

The graft copolymer can be processed by various methods known in the art, such as extrusion pelletizing, injection molding, and film forming. For example, the starch-polyester graft copolymer compositions can be injection molded to give a variety of molded products, and extrusion cast or even solution cast to give translucent flexible films, as well as transparent films.

Preferably, the melt-blended starch-polyester graft copolymer is further processed by thermoforming to form a thermoformed article. Thermoforming is a manufacturing process for thermoplastic sheet or film, converting the sheet or film into a formed, finished part. The starch-polyester graft copolymer sheet is heated in an oven to its forming temperature (e.g., about 80° C. to about 250° C. or about 100° C. to about 200° C.) for a time sufficient to render the sheet flexible (e.g., about 10 sec to about 100 sec), then the sheet is stretched into or onto a mold and cooled. The graft copolymer sheet can be any suitable thickness based on the intended use of the final thermoformed article, but suitably ranges from about 0.1 mm to about 5 mm, for example about 0.2 mm to about 2 mm or about 0.3 mm to about 1 mm. The molds can be formed from a variety of materials, for example including cast or machined metal (e.g., aluminum), epoxy, wood, and structural foam. Metallic/aluminum molds can be water-cooled. A thermoform machine can utilize a vacuum, or a vacuum combined with air pressure, in the forming process to conform the heated, flexible copolymer sheet to the mold.

### EXAMPLES

The following examples illustrate the disclosed compositions and methods, but are not intended to limit the scope of any claims thereto. Examples of materials made in accordance with the present disclosure in compost experiments confirm biodegradability.

### Examples 1-8

Examples 1-8 demonstrate the utility of compositions according to the present invention for forming biodegradable products containing a biodegradable starch or plasticized starch and biodegradable polyester in the presence of a trans-esterification catalyst (e.g., dibasic organic acid, and/or anhydride thereof, for example maleic anhydride).

### Example 1

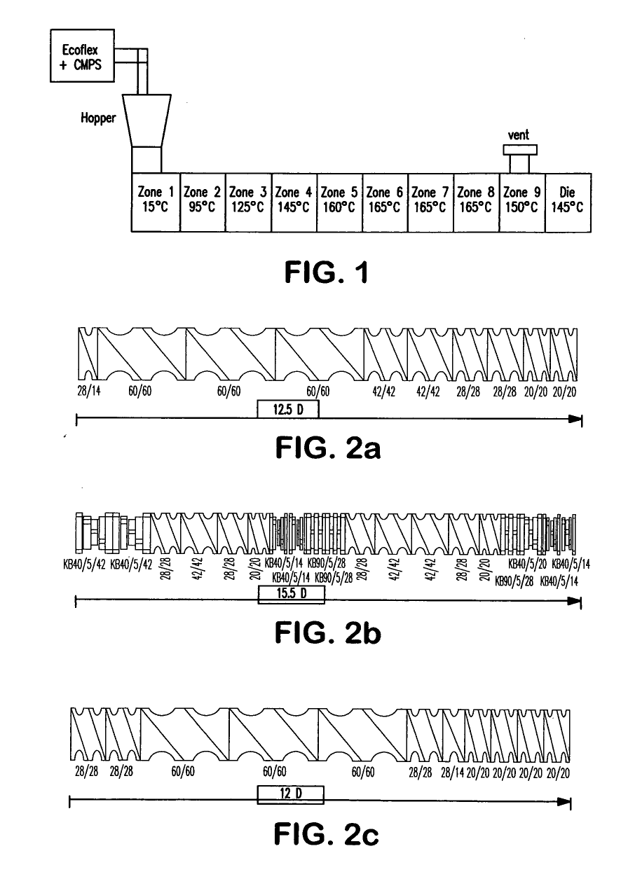

The synthesis of PBAT-plasticized starch (PS) graft copolymers was accomplished in a twin-screw co-rotating CENTURY extruder using maleic acid as a trans-esterification catalyst. PS was produced by plasticization of regular corn-starch, obtained from Corn Products, Inc. (Chicago, Ill.) (moisture content of 12%) using glycerol (20-wt %) as a plasticizer in the same extruder. Maleic acid, obtained from Aldrich, was ground to a fine powder using a mortar and pestle and pre-blended with the ECOFLEX polyester (poly (butylene adipate-co-terephthalate)), obtained from BASF (Germany)) before being fed to the feed port of the extruder. The concentration of maleic acid used was 1-wt % with respect to the total concentration. Meanwhile, PS, previously oven dried overnight at 50° C., was ground to a fine powder and fed using an external feeder to the feed port of the extruder. The feeder rates were adjusted accordingly to obtain a ratio of 70:30 ECOFLEX/maleic acid:PS. The temperature profile is shown in FIG. 1 and Table 1, and the screw configuration used is shown in FIG. 2, respectively. In FIGS. 2A, 2B and 2C, the entire screw configuration is divided into 3 sections; section 1 of 12.5D distance followed by section 2 of 15.5D distance and finally section 3 with 12D distance. The vent port was kept open to remove unreacted maleic acid and water. The extruded strand was cooled using a water bath and pelletized in line.

TABLE 1
Extrusion Processing Conditions in the
synthesis of Polyester-(PS/CMPS) graft copolymers

| ZONE | SET | ACTUAL | UNITS |
|---|---|---|---|
| ZONE 1 | 15 | 70 | ° C. |
| ZONE 2 | 95 | 99 | ° C. |
| ZONE 3 | 125 | 122 | ° C. |
| ZONE 4 | 145 | 149 | ° C. |
| ZONE 5 | 160 | 170 | ° C. |
| ZONE 6 | 165 | 192 | ° C. |
| ZONE 7 | 165 | 196 | ° C. |
| ZONE 8 | 165 | 193 | ° C. |
| ZONE 9 | 150 | 185 | ° C. |
| DIE | 145 | 153 | ° C. |

| | | |
|---|---|---|
| MELT TEMP. | 153 | ° C. |
| MOTOR SPEED | 254 | RPM |
| TORQUE | 67 | % |
| PRESSURE | 92 | Psia |
| FEEDER SPEED, CENTURY (Ecoflex + | 135 (~8 lb/hr) | % |
| Maleic acid) | | |
| FEEDER SPEED, MINI | | % |
| FEEDER SPEED, EXT (TPS) | 0.80 (3.4 lb/hr) | % |

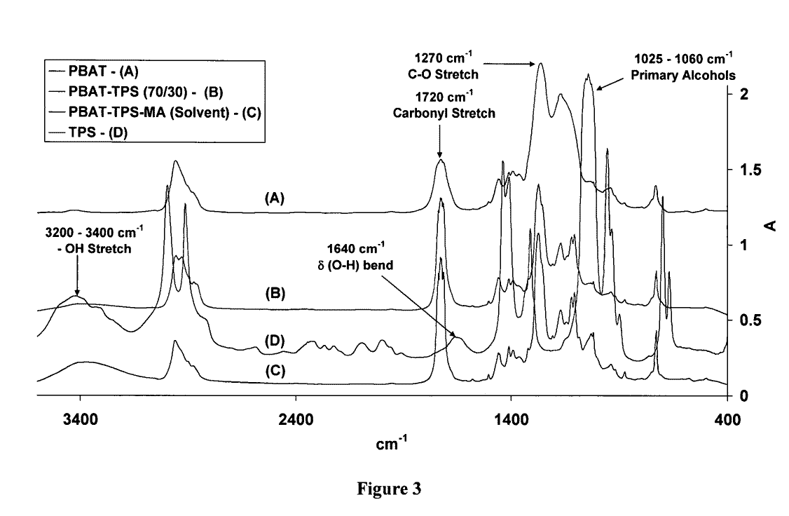

The resulting pellets were dried in an oven overnight at 75° C. The pellets were totally extracted in dichloromethane using a soxhlet extraction unit. The extracted graft copolymer solution was cast to form transparent films. FTIR analysis (FIG. 3) of the films confirmed reactivity and the true existence of a graft copolymer.

### Example 2

The procedure of Example 1 was followed using PCL (Poly (epsilon-caprolactone), obtained from Dow Chemical (Midland, Mich.); Molecular weight of 70,000 g/mol) polyester instead of PBAT. The resulting pellets were also dried in an oven overnight at 75° C. The pellets were totally extracted in dichloromethane using a soxhlet extraction unit. The extracted graft copolymer solution was cast to form transparent films. FTIR analysis of the films confirmed reactivity and the true existence of a graft copolymer.

### Example 3

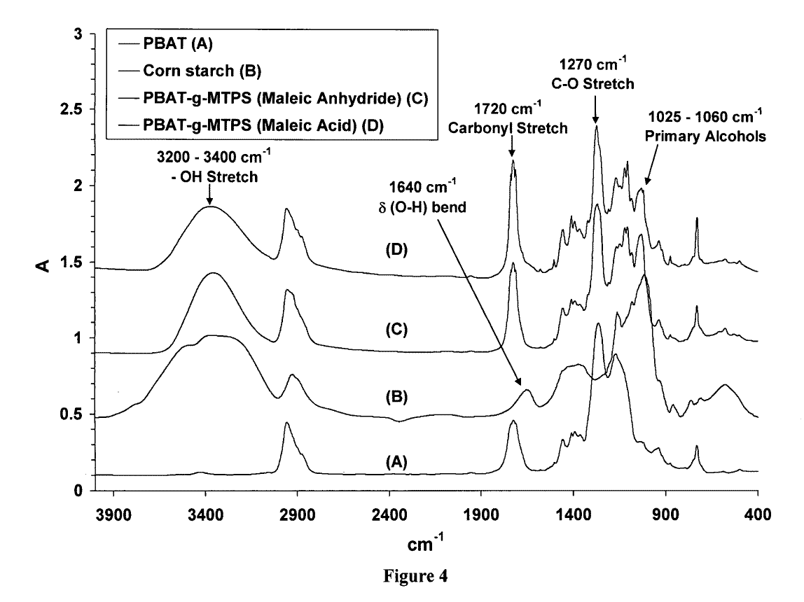

The synthesis of starch-polyester graft copolymers was carried out as follows: Chemically modified plasticized starch (CMPS), produced by reactive extrusion processing of regular corn-starch, obtained from Corn Products (Chicago, Ill.), using maleic acid modifier, and glycerol (20-wt %) plasticizer as explained in U.S. Pat. No. 7,153,354 (incorporated by reference) was oven dried overnight at 75° C. and ground to a fine powder and fed using an external feeder to the feed port of the extruder. PBAT (ECOFLEX) was also fed to the feed port of the extruder using a CENTURY feeder (Traverse City, Mich.). The feeder rates were adjusted accordingly to obtain a ratio of 70:30 (PBAT:CMPS). The temperature profile and the screw configuration used are similar to Example 1. The vent port was kept open to remove unreacted maleic acid and water. The extruded strand was cooled using a water bath and pelletized in line. The pellets were dried in an oven overnight at 75° C., to remove surface moisture. The pellets were totally extracted in dichloromethane using a soxhlet extraction unit. The extracted graft copolymer solution was cast to form transparent films. FTIR analysis of the films (FIG. 4) confirmed reactivity and the true existence of a graft copolymer.

### Example 4

The synthesis of starch-polyester graft copolymers was carried out as follows: Chemically modified plasticized starch (CMPS), produced by reactive extrusion processing of regular corn-starch, obtained from Corn Products, using maleic acid modifier, BENTONE 166 (an alkylaryl ammonium hectorite clay, obtained from Elementis Specialties, having greatly improved dispersibility characteristics and providing excellent mechanical strength, flame retardancy, and highly improved gas barrier properties), and glycerol (20 wt %) plasticizer as explained in U.S. Pat. No. 7,153,354 was oven dried overnight at 75° C. and ground to a fine powder and fed using an external feeder to the feed port of the extruder. PBAT was also fed to the feed port of the extruder using the CENTURY feeder. The feeder rates were adjusted accordingly to obtain a ratio of 70:30 (PBAT:CMPS). The temperature profile and the screw configuration used are similar to Example 1. The vent port was kept open to remove maleic acid and water. The extruded strand was cooled using a water bath and pelletized in line. The pellets were dried in an oven overnight at 75° C., to remove surface moisture.

### Example 5

The synthesis of starch-polyester graft copolymers was carried out as follows: Chemically Modified plasticized starch (CMPS), produced by reactive extrusion processing of regular corn-starch, obtained from Corn Products, using maleic acid modifier, BENTONE 111 (an organic derivative of a special smectite clay, obtained from Elementis Specialties, providing excellent mechanical strength, flame retardancy, and highly improved gas barrier properties) and glycerol (20 wt %) plasticizer as explained in U.S. Pat. No. 7,153,354 was oven dried overnight at 75° C. and ground to a fine powder and fed using an external feeder to the feed port of the extruder. PBAT was also fed to the feed port of the extruder using CENTURY feeder. The feeder rates were adjusted accordingly to obtain a ratio of 70:30 (PBAT:CMPS). The temperature profile and the screw configuration used are similar to Example 1. The vent port was kept open to remove maleic acid and water. The extruded strand was cooled using a water bath and pelletized in line. The pellets were dried in an oven overnight at 75° C., to remove surface moisture.

### Example 6

The procedure given in Example 3 was followed using polycaprolactone (PCL) polyester instead of PBAT. The resulting pellets were also dried in an oven overnight at 75° C. The pellets were totally extracted in dichloromethane using a soxhlet extraction unit. The extracted graft copolymer solution was cast to form transparent films. FTIR analysis of the films confirmed reactivity and the true existence of a graft copolymer.

### Example 7

PBAT (ECOFLEX) and cross-linked PBAT (LECOFLEX, cross-linked using a free radical initiator) were melt extruded with PS (e.g., starch and glycerol) and CMPS (e.g., starch, glycerol, maleic anhydride, optionally with a peroxide initiator) in different proportions according to the procedure as explained in Example 3. All the samples were extracted in dichloromethane using a soxhlet apparatus. The results of the extraction are shown in Table 2.

TABLE 2
Soxhlet Extraction results of PBAT-CMPS graft copolymers

| | Polyester | Starch | | |
|---|---|---|---|---|
| | (Ecoflex | component | | |
| | or | (PS or | | |
| | LEcoflex) | CMPS) | | |
| | initially | initially | Material | |
| | present | present | extracted | % |
| System | (gm) | (gm) | (gm) | Extracted |
| Ecoflex/CMPS | 1.3510 | 0.579 | 1.8878 | 98 |
| (70/30; w/w) | | | | |
| Ecoflex/CMPS | 1.0682 | 0.7122 | 1.7010 | 96 |
| (60/40; w/w) | | | | |
| Ecoflex/CMPS | 0.7998 | 0.7998 | 0.7503 | 47 |
| (50/50; w/w) | | | | |
| Ecoflex/CMPS | 0.8639 | 0.5759 | 0.5513 | 38.2 |
| (40/60; w/w) | | | | |
| Ecoflex/CMPS | 1.9018 | 0.8150 | 2.6530 | 98 |
| (70/30; w/w) | | | | |
| No Initiator | | | | |
| used in the | | | | |
| preparation | | | | |
| of CMPS. | | | | |
| Ecoflex/PS | 1.2075 | 0.5175 | 1.2595 | 71 |
| (70/30; w/w) | | | | |
| LEcoflex/CMPS | 3.25 | 1.748 | 4.1272 | 83 |
| (65/35; w/w) | | | | |
| LEcoflex/PS | 1.0225 | 0.4382 | 1.0602 | 73 |
| (70/30; w/w) | | | | |

As seen from Table 2, almost complete extraction is achieved for PBAT-CMPS (70/30 w/w and 60/40 w/w) graft copolymers. When this solution was cast, a transparent film was obtained. This proves that PBAT and CMPS are covalently linked, making the graft copolymer extractable in dichloromethane (i.e., solvent wherein PBAT is soluble, but starch/plasticized starch is not). However, due to the insolubility of PS in the solvent, the graft copolymer forms a colloidal dispersion, and not a clear transparent solution.

This result is applicable even to blends containing CMPS made with no peroxide initiator (e.g., as in row 5 of Table 2). However, for the 50/50 and 40/60 blends, only 47% and 38%, respectively, were extracted out (i.e., an amount that is close to the respective PBAT amount). This confirms the fact that PBAT has not reacted with CMPS in those blends. Thus, the reaction is also dependent on the relative amounts of the polyester and CMPS phases present. Also, from Table 2 (i.e., rows 6 and 8), it is clearly seen that when PS is used instead of CMPS, there is very minimal or no reaction taking place. This suggests that the reaction between the hydroxyl groups in starch and the ester functionalities in PBAT occurs only in the presence of a trans-esterification catalyst such as maleic acid. When PBAT polyester was cross-linked (i.e., LECOFLEX) and reactively blended with CMPS, around 83% of the polyester was extracted out. This could be due to the fact that certain gel (network) portions of the cross-linked polyester are impermeable to chemical reaction.

### Example 8

Several graft copolymer samples, prepared using both PS and CMPS according to procedures explained in Examples 1, 3, 4, and 5 were extruded into films. Films were made using a Killion (Pawcatuck, Conn.) single-screw blown film unit. The screw diameter was 25.4 mm with a L:D ratio of 25:1. The die inner diameter was 50.8 mm with a die gap size of 1.5 mm. The blown film processing conditions are shown in Table 3.

TABLE 3
Blown film processing conditions for PBAT-(PS/CMPS) graft copolymers

| | | | | | | | | |
|---|---|---|---|---|---|---|---|---|
| Set (° F.) | 70 | 350 | 355 | 360 | 360 | 395 | 395 | 300 |
| Actual (° F.) | 73 | 351 | 358 | 357 | 360 | 380 | 395 | 300 |

| | |
|---|---|
| Melt (° F.) | 364 |
| Screw Speed (RPM) | 12.4 |
| FPM (ft/min) | 5-6 |
| Pressure (psi) | 500-1000 |

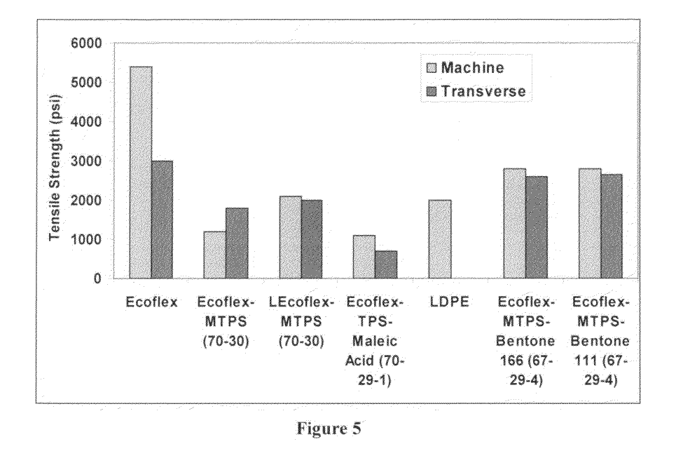

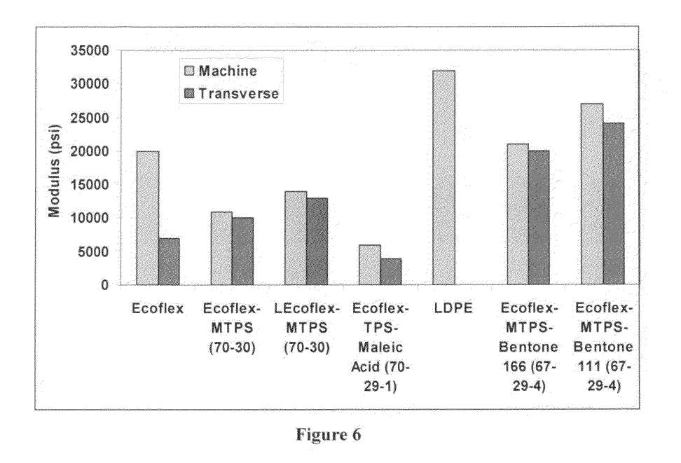

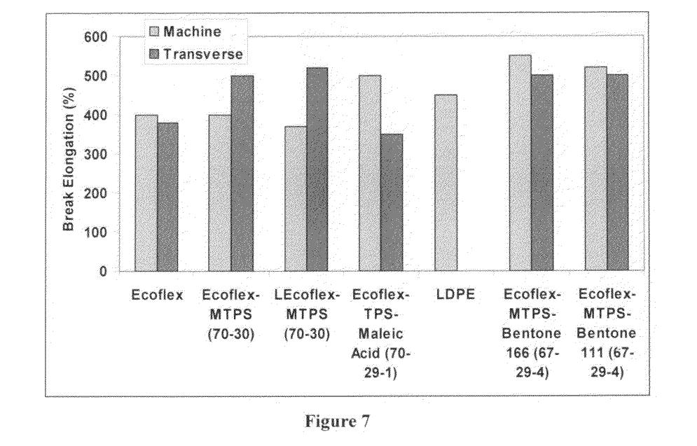

Tensile Property Evaluation: Tensile properties of the films (of Example 8) were determined using INSTRON Mechanical Testing Equipment fitted with a 100 lb load cell. The crosshead speed was 1 inch per minute. Rectangular film samples, 4′×1′ dimension, were conditioned at 23° C. and 50% Relative Humidity for 40 hours before being tested according to ASTM D-882 testing. The results of the testing are shown in FIGS. 4, 5 and 6. It is observed that the tensile strength and modulus of elasticity values of ECOFLEX-PS graft copolymer, containing around 30% PS, exhibit almost a six fold decrease as compared to pure ECOFLEX polyester values. However, ECOFLEX-CMPS graft copolymers and cross-linked ECOFLEX (LECOFLEX)-CMPS graft copolymers exhibit tensile values comparable to LDPE. Also, on incorporation of clay in the production of ECOFLEX-CMPS, the film tensile strength further improves to about 2800-3000 psi (i.e., twice as much as ECOFLEX:CMPS). Break elongation values of the graft copolymer are higher than ECOFLEX and LDPE. Tear and Puncture properties, determined according to ASTM D1922 and ASTM F1306, respectively, were found to be comparable to LDPE (Table 4).

TABLE 4
Tear and puncture properties of PBAT-CMPS (70/30) graft copolymer

| | | Tear (g) | Tear (g) | Puncture | Puncture |
|---|---|---|---|---|---|
| | | MD | CMD | Max. (lb_{f}) | Ext. (in) |
| | | ASTM | ASTM | ASTM | ASTM |
| Material | Thickness (in) | D1922 | D1922 | F1306 | F1306 |
| LDPE | 0.0010-0.0015 | 100-300 | — | 1.5-3.0 | — |
| Ecoflex- | 0.0010-0.0015 | 767.7 | 802.7 | 1.515 | 0.6219 |
| MTPS | | | | | |
| (70/30) graft | | | | | |
| copolymer | | | | | |

The above examples demonstrate that the composite materials provide new starch-based graft copolymers which utilize agricultural resources that can be returned back to nature in an environmentally sound manner. The polymeric materials are environmentally compatible, this being achieved by designing and engineering fully biodegradable materials that are thermoplastic, yet breakdown under appropriate environmental conditions in a manner similar to their lignocellulosic counterparts.

### Examples 9-16

Examples 9-16 include composite formulations of thermoplastic starch or maleated thermoplastic starch with poly(butylene adipate-co-terephthalate) that are extruded, pelletized, extruded into sheets, and then thermoformed into an article for characterization and analysis.

Materials: High amylose corn starch was purchased from National Starch and Chemicals (Indianapolis, Ind.). Regular corn starch was obtained from Cargill Inc. (Minneapolis, Minn.). Poly(butylene adipate-co-terephthalate) (PBAT) was purchased from BASF Chemicals (Ludwigshafen, Germany), under the trade name ECOFLEX. Anhydrous glycerol (99.9% assay) was purchased from J. T. Baker (Phillipsburg, N.J.). Maleic anhydride was purchased from Sigma-Aldrich, Inc (St. Louis, Mo.). The initiator, 2,5-bis(tert-butylperoxy)-2,5-dimethylhexane, also referred to as LUPEROX 101, was purchased from Sigma-Aldrich, Inc (St. Louis, Mo.).

Equipment: A Century CX-30 co-rotating twin-screw extruder, having a length/diameter ratio (L/D) of 42 and a screw diameter of 30 mm, was used to prepare the thermoplastic starch and maleated thermoplastic starch, and further to blend these materials with PBAT. A pelletizer was used to cut the extrudate strands into small pellets. The blended material was then extruded through a Killion single-screw extruder, having a length/diameter ratio (L/D) of 24 and a screw diameter of 1 inch. The extrudate exited the extruder in the form of a sheet of material and was collected on a roller. Thermoforming of the sheets of blended material was performe using a Labform thermoformer (Hydro-Trim Corporation; West Nyack, N.Y.).

Production of thermoplastic starch (TpS) and modified thermoplastic starch (MTpS): Thermoplastic starch (TpS) was produced in a co-rotating twin-screw CX-30 extruder. The corn starch (high amylose or regular) was fed into the feed port of the extruder using an external feeder. Glycerol, which was warmed in a water bath, was pumped into the extruder using a peristaltic pump. The feed rates of the external feeder and the peristaltic pump were set so as to accomplish a composition of 70 wt % starch and 30 wt % glycerol. The total flow of all material through the extruder was approximately 11 kg/h. The temperature profile of the extruder was 25/115/120/125/130/135/135/135/130/130° C. from the feed throat to the die. The screw speed was set to 125 rpm. The vent port was kept open to remove any moisture. The extruded strand was air-cooled and pelletized in line. The pellets were dried for two days in an oven at 65° C. before being blended with PBAT.

Maleated thermoplastic starch (MTpS) was produced in a co-rotating twin-screw CX-30 extruder. Maleic anhydride was ground into a fine powder using a mortar and pestle and pre-blended with the corn starch (high amylose or regular) before being fed into the feed port of the extruder. The concentration of maleic anhydride used was 2 wt % with respect to the total mass. LUPEROX 101 was pumped into the feed throat of the extruder using a peristaltic pump. The concentration of LUPEROX 101 used was 0.1 wt % with respect to the total mass. Glycerol, which was warmed in a water bath, was pumped into the extruder using a peristaltic pump. The feed rates of the external feeder and the peristaltic pump for the glycerol were set so as to accomplish a composition of 80 wt % starch and 20 wt % glycerol. The total flow of all material through the extruder was approximately 11 kg/h. The temperature profile of the extruder for producing maleated thermoplastic starch was 25/95/125/145/160/165/165/165/150/145° C. from the feed throat to the die. The screw speed was set to 125 rpm. A vacuum was pulled on the vent port of the extruder in order to remove unreacted maleic anhydride and moisture. The extruded strand was air cooled and pelletized in line. The pellets were dried for two days in an oven at 65° C. before being blended with PBAT.

The temperature profile used with the maximum temperature of 165° C. was defined in preliminary tests as the best temperature for production of MTPS of high amylose corn starch with 20% glycerol, as it was not possible to make TPS with 20% glycerol in twin-screw extruder due to its high viscosity. For comparison purposes, TpS and MTpS were also produced under the same conditions: with a temperature profile of 25/95/115/125/130/135/135/135/130/130° C., 30% glycerol, 2% maleic anhydride, and 0.1% LUPEROX. This was done to compare the modified and non-modified thermoplastic starch of the high amylose corn starch and regular corn starch.

Blend production of TpS and MTpS with PBAT: Blends of TpS/PBAT or MTpS/PBAT were produced in a co-rotating twin-screw CX-30 extruder. Pellets of TPS or MTPS were pre-mixed with PBAT in various weight ratios of TpS/MTpS to PBAT ratios (60:40, 50:50, and 0:100 (i.e., a PBAT reference sample)) and fed into the feed port of the extruder using an external feeder. The temperature profile of the extruder was 25/125/135/140/145/150/150/150/145/135° C. from the feed throat to the die. The screw speed was set to 100 rpm. The vent port was kept open to remove any moisture. The extruded strand was air-cooled and pelletized in line. The pellets were dried for one day in an oven at 65° C. before being extruded into sheets. Table 5 summarizes the composition and processing parameters for Examples 9-16. In the “starch” column of Table 5, “H” and “R” refer to the inclusion of high amylose or regular cornstarch, respectively.

TABLE 5
Composition of TpS/MTpS Blends with PBAT

| | | | | | | TpS/MTpS-PBAT | | |
|---|---|---|---|---|---|---|---|---|
| | TpS/MTpS Formulation (wt. parts) | | | | | Blend (wt. %) | | |
| Example | Max. T | Starch | Glycerol | MA | Luperox | TpS | MTpS | PBAT |
| 9 | 165° C. | 80 H | 20 | 2 | 0.1 | — | 60 | 40 |
| 10 | 165° C. | 80 H | 20 | 2 | 0.1 | — | 50 | 50 |
| 11 | 165° C. | 80 R | 20 | 2 | 0.1 | — | 50 | 50 |
| 12 | 135° C. | 70 H | 30 | 2 | 0.1 | — | 50 | 50 |
| 13 | 135° C. | 70 R | 30 | 2 | 0.1 | — | 50 | 50 |
| 14 | 135° C. | 70 H | 30 | — | — | 50 | — | 50 |
| 15 | 135° C. | 70 R | 30 | — | — | 50 | — | 50 |
| 16 | n/a | n/a | n/a | n/a | n/a | — | — | 100 |

Thermoforming Processing: Extruded sheets of the blended material were produced in a single-screw extruder. The pellets were gravity-fed into the extruder at the feed throat. The temperature profile of the extruder was 160/160/160/160/154° C. for zone 1, zone 2, zone 3, clamp ring, and die, respectively. The screw speed was set to 65 rpm. The extruded sheet was cooled on a chill roller set at 21° C. and then collected on an auxiliary roller. The speed of the chill roller was adjusted so as to produce a sheet with a thickness of 500 μm.

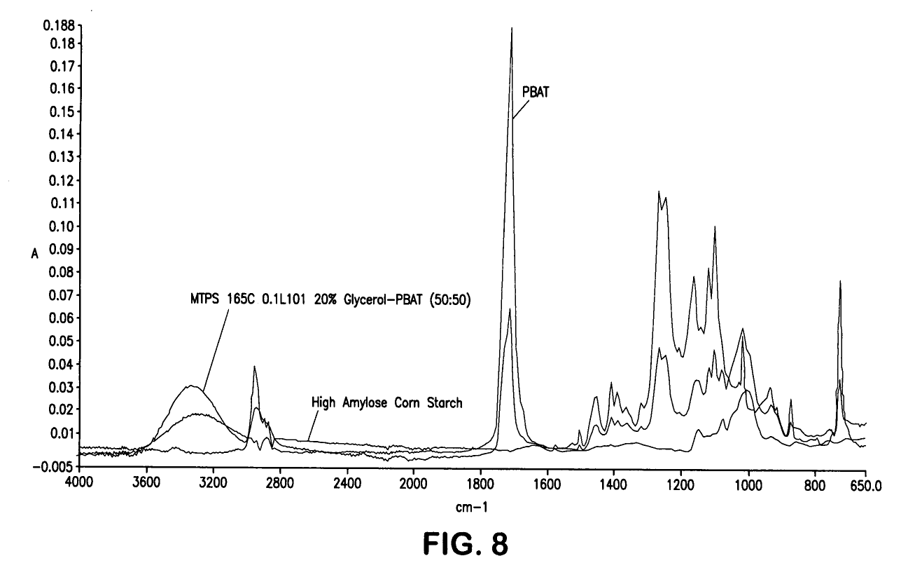

Pieces of the sheets were cut with scissors and placed in the Labform thermoformer. The upper and lower heaters of the thermoformer were both set to 154° C. The thermoformer held the sheet of material between the upper and lower heaters for varying lengths of time (from 24 to 40 seconds), depending on the composition of the material. The length of time was determined so as to ensure that the material was adequately heated, but did not sag too much. The material was then placed over the forming die and a vacuum of approximately 25 mmHg was pulled and held for 20 seconds. The thermoformed object could then be removed from the thermoformer and the excess material around the object was trimmed away with scissors. The object formed was an open tray/container, as shown in FIG. 8.

Fourier Transform Infrared Spectroscopy analysis (FTIR): The FTIR spectra of TpS, MTpS, starch, and blends of TpS or MTpS with PBAT pellets were scanned from 650 cm⁻¹ to 4000 cm⁻¹ using a Perkin Elmer Spectrum One FT-IR Spectrometer. To prove that grafting had occurred between the MTpS and the PBAT, a soxhlet extraction in dichloromethane was performed on the pellets of the MTpS/PBAT blends. In this analysis, the PBAT is soluble in dichloromethane but starch is not; therefore, the soxhlet extraction removes and recovers the PBAT, glycerol and starch that is grafted on the PBAT backbone. FTIR spectra of the pellets before soxhlet extraction and after soxhlet extraction were obtained. Also, the solvent was collected after the extraction and evaporated, leaving a film whose FTIR spectrum was recorded.

In FIG. 8, the FTIR spectra for high amylose (HA) starch, PBAT, and a blend of MTPS-PBAT (Example 10) is shown. Both the PBAT and the blend show a carbonyl stretch peak at 1710 cm⁻¹. They also show the ester C—O stretch at 1265 cm⁻¹. This is not observed in the HA starch sample. The HA starch and the blend samples exhibit a peak between 3200-3400 cm⁻¹. This corresponds to the —OH stretch from starch and glycerol.

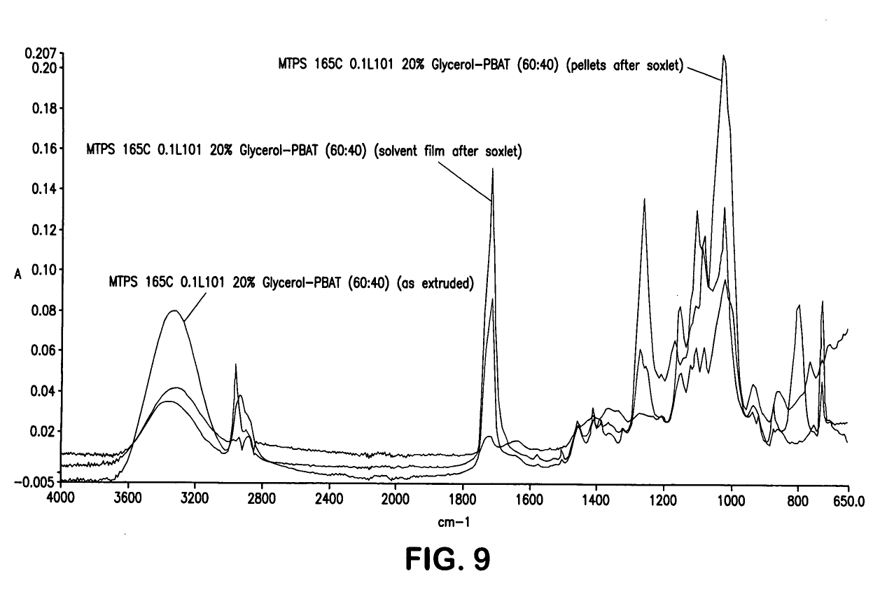

FIG. 9 shows the FTIR spectra for the blend of MTPS-PBAT (Example 9) of (1) the as-extruded pellets, (2) the pellets after soxhlet extraction in dichloromethane, and (3) the film produced when the solvent from the soxhlet extract was evaporated. It is observed that the blend and the solvent film show a carbonyl stretch peak at 1710 cm⁻¹. This is similar to what is observed for pure PBAT. Also, the ester C—O stretch at 1265 cm⁻¹ is exhibited in these two samples.

The grafting of MTPS and PBAT is difficult to prove by FTIR analysis, due to the fact that PBAT has an expressive peak close to the peak from carbonyl stretch at 1710 cm⁻¹, and almost all of the starch peaks are underneath the PBAT curve, except the peak corresponding to —OH stretch. It can be observed that the solvent film after soxhlet extraction presented one difference in relation of the curve for PBAT (FIG. 1): the peak between 3200-3400 cm⁻¹, that corresponds to the —OH stretch from starch and glycerol. This indicates that the starch, glycerol, or both were extracted in dichloromethane with the PBAT.

Mechanical Testing: Tensile samples of the blends of TpS and MTpS/PBAT blends were conditioned as recommended in standard method ASTM D-4332 (incorporated herein by reference), in a constant environment room at 23+/−1° C. and 50+/−2% RH for at least 40 hours before testing. The tensile tests were measured in accordance with ASTM D-882-91 method (1996; incorporated herein by reference). Specimens (100 mm×25 mm) of the extruded sheets of each formulation were clamped between the grips. Force-extension curves were recorded. The parameters determined were: tensile strength, modulus, and elongation. Seven samples were tested for each blend and property.

One control sample, PBAT, was tested to evaluate the effect of blends of TPS and MTPS with PBAT on mechanical properties of sheets and thermoforming pieces. Analysis of variance (ANOVA), Tukey mean comparison test (p≦0.05) and regression analysis were performed employing Statistica software (Statsoft; Oklahoma, USA).

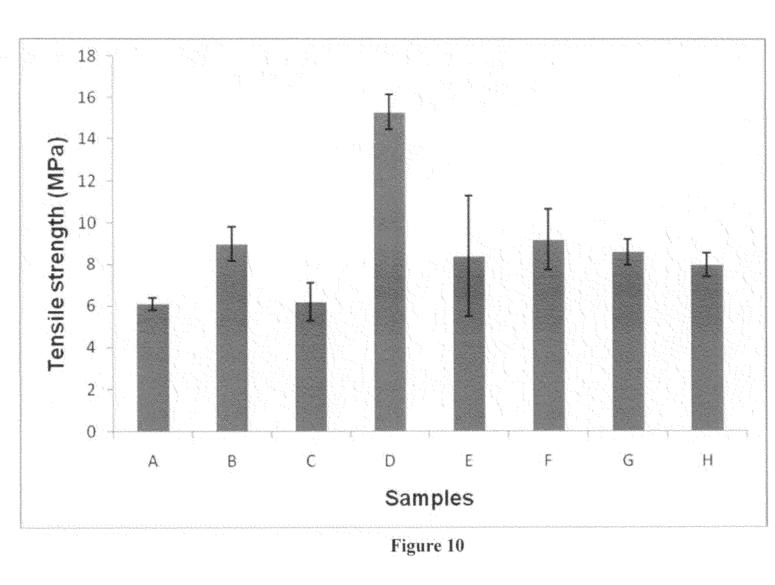

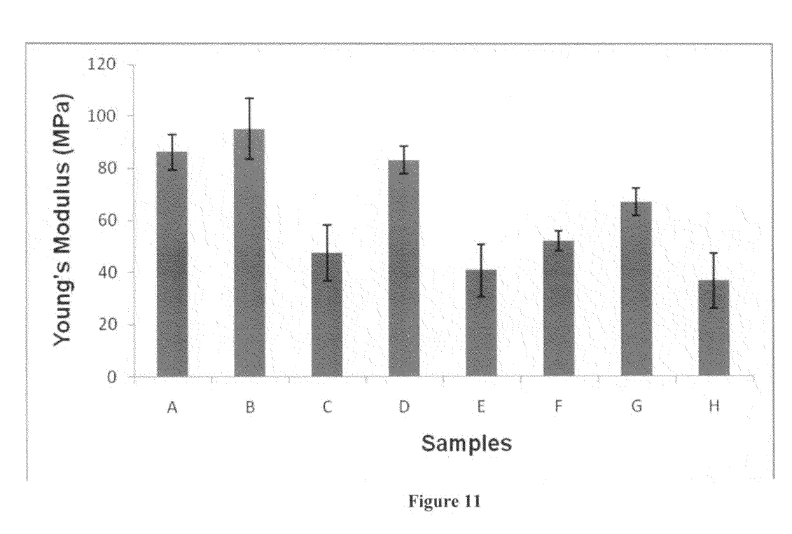

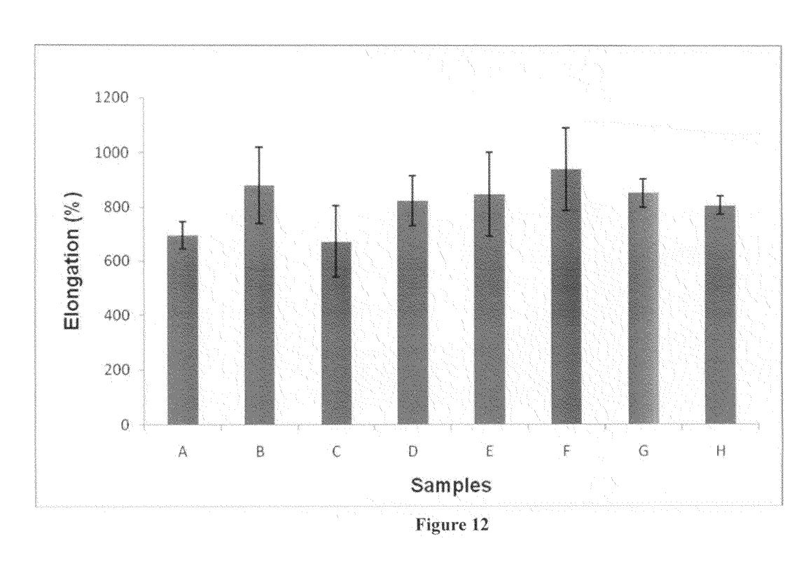

The mechanical properties of polymeric materials provide relevant performance metrics based on the intended application of the material. The effect of: (a) the temperature profile used in the extrusion of MTPS, (b) the effect of the ratio of MTPS/PBAT of the blends, and (c) the effect of the starch source impacts the performance properties, and is discussed. Table 6 presents the tensile measurements of the sheets of TPS and MTPS/PBAT blends. In Table 6, labels A-H in the “Example” column correspond to the labels in FIGS. 10-12, and different superscripts within the same column indicate that two results are statistically different (p≦0.05). The data of Table 6 are also illustrated in FIGS. 10-12.

TABLE 6
Thickness and Mechanical Properties of TpS/MTpS Blends with PBAT

| | Thickness | | Modulus | Elongation |
|---|---|---|---|---|
| Example | (μm) | Tensile Strength (MPa) | (MPa) | (%) |
| 9 (A) | 518.9 ± 21.64^{a} | 6.1 ± 0.31^{a} | 86.0 ± 6.69^{a} | 697.0 ± 50.60^{a} |
| 10 (B) | 515.8 ± 6.15^{a} | 9.0 ± 0.82^{b} | 95.0 ± 11.71^{a} | 881.0 ± 139.13^{b,c,d} |
| 11 (C) | 498.6 ± 27.50^{a} | 6.2 ± 0.93^{a} | 47.6 ± 10.79^{b,c} | 673.2 ± 131.84^{a,d} |
| 12 (E) | 508.4 ± 24.56^{a} | 8.4 ± 1.46^{b} | 40.7 ± 3.87^{b,e} | 946.8 ± 151.35^{b,c,d} |
| 13 (F) | 506.5 ± 9.82^{a} | 9.2 ± 0.62^{b} | 52.1 ± 5.10^{c} | 938.6 ± 52.27^{b} |
| 14 (G) | 524.7 ± 20.26^{a} | 8.6 ± 0.57^{b} | 67.1 ± 10.64^{d} | 852.5 ± 33.27^{c} |
| 15 (H) | 508.7 ± 9.81^{a} | 8.0 ± 0.99^{b} | 36.6 ± 4.21^{e} | 807.2 ± 111.20^{c,d} |
| 16 (D) | 510.2 ± 24.60^{a} | 15.3 ± 2.90^{c} | 83.1 ± 10.12^{a} | 824.1 ± 153.45^{a,b,c,d} |

In examining the tensile strength of MTPS/PBAT sheets at 165° C. and 20% glycerol (Examples 9-11), the increase of MTPS content to 60% decreased the tensile strength from 9.0 to 6.1 MPa. Comparing the MTPS samples of high amylose corn starch (Example 10) and of regular corn starch (Example 11), one can observe the effect of composition of starch on tensile properties. The blend using MTPS of high amylose corn starch (70% amylose) presented higher tensile strength (9.0 MPa; Example 10) than the blend using MTPS of regular corn starch (25-28% amylose) (6.2 MPa; Example 10). This could be attributed to the linear structure of amylose chains at lower glycerol content. According to Rindlav-Westling et al.²⁶, the amylose network structure is very stable, with strong molecular orientation, forming films denser than amylopectin films. Higher amounts of amylose in starches give stronger films, while the branched structure of amylopectin generally leads to films with decreased tensile stress.²⁷⁻²⁹

For the samples of sheets of TPS or MTPS with PBAT at 135° C. and 30% glycerol Examples 12-15), the tensile strength did not show a significant variation (p≦0.05), probably due mainly to the effect of glycerol. For blends of MTPS/TPS with 30% glycerol, the effect of glycerol on tensile properties is more effective than the effect of the amylose/amylopectin ratio, and the effect of the different thermoplastic starch used (modified and non-modified).

These values for the tensile strength for TPS or MTPS blends with PBAT were higher than blends of cassava TPS with the biodegradable polymer PBSA (polybutylene succinate adipate) reported in literature: 5.2 MPa for TPS/PBSA (30:70) and 7.0 MPa for TPS/PBSA (70:30). However, the values of tensile strength for TPS and MTPS blends were lower than those of synthetic films, such as HDPE (high density polyethylene) or LDPE (low density polyethylene), which present a stress at break of 16 MPa and 26 MPa, respectively.

The samples of blends of MTPS made with high amylose corn starch (60% and 50% MTPS) and PBAT at 165° C. (Examples 9 and 10) had similar Young's modulus values. However, the MTPS of regular corn starch in the same conditions presented a lower Young's modulus than the other samples at 165° C. (47.6 MPa; Example 11) and a lower Young's modulus than PBAT (83 MPa; Example 16). Comparing the samples of MTPS and TPS at 135° C. (Examples 12-15), the Young's modulus values are lower than for PBAT (Example 16).

Comparing all samples of sheets of TPS/PBAT and MTPS/PBAT (Examples 9-15) with sheets of PBAT (Example 16), the elongation of the samples did not show significant differences (p≦0.05). These results are likely due to high elongation of pure PBAT. In general, the results for elongation indicate that blends of MTPS and TPS with higher glycerol content (30%) and PBAT, in the ratio of 50:50, exhibited elongation comparable to that of pure PBAT.

The elongation depends of the interactions among the blend components and natural elongation of the polymers used. One of the characteristics of PBAT is its high elongation (˜800%). The addition of 50% of TPS or MTPS and 60% of MTPS made from high amylose starch, did not significantly change the original elongation from that of the pure PBAT. These values were higher than those of other blends of TPS with other biodegradable polymers reported in literature (e.g., PBSA (elongation of 233%) and PLA (elongation at break varying from 5 to 20%)) and higher than those of synthetic films (e.g., HDPE (strain at break of 300%) and LDPE (strain at break of 500%).

According to Myllarinen et al.³⁰, glycerol and starch polymers are strongly interacted, and at low glycerol contents (<20%), this interaction results in more brittle and stronger networks. Here, the samples of 20% glycerol (Examples 9-11) had limited improvement in tensile strength due to the effect of the higher extrusion temperature of 165° C. The samples of 20% (Examples 9-11) and 30% (Examples 12-15) of glycerol were extruded at different temperature profiles (maximum temperature of 165° C. and 135° C., respectively). In this way, the lower glycerol content positively affected the tensile strength while the high temperature profile used negatively affected the tensile strength, due to the higher degradation of maleated samples at this temperature.

Puncture Testing: Puncture tests were performed on the sheets and the thermoforming samples to determine puncture strength (N) and deformation (mm) using a TA.TX2i Stable Micro Systems texture analyzer (Surrey, England). Samples of diameters of 40 mm were fixed on the plate of the equipment with a hole of 20 mm diameter with help of tape (3M Scotch, Brazil). A cylindrical probe of 5 mm diameter was moved perpendicularly to the sheets surface at a constant speed of 1 mm/s until the probe passed through the film. Force-deformation curves were recorded. At the rupture point, force and deformation were determined. Each data point on the graph represents an average of four points.

The resistance of a material to puncture is a quality control parameter for materials used to contain products with sharp extremities or products that could be damaged from external forces during storage or distribution. Due to the shape and size of the thermoformed samples, it was not possible perform tensile tests on the thermoformed pieces. However, puncture tests of the blends after thermoforming were performed. Table 7 shows the thickness (“T” in μm), puncture strength (“PS” in N) and puncture deformation (“PD” in mm) for the samples. Example 11 was not able to be thermoformed effectively, as it produced a thermoformed object that was irregular in shape and thickness. Puncture tests of the thermoformed pieces were not run for Example 111 and for neat PBAT (Example 16) due to neat PBAT's extreme flexibility.

TABLE 7
Puncture Tests of Thermformed TpS/MTpS Blends with PBAT

| | Thickness | Puncture Strength | Puncture Deformation |
|---|---|---|---|
| Example | (μm) | (N) | (mm) |
| 9 | 283 ± 9.6^{a} | 26.0 ± 0.80^{a} | 10.3 ± 0.44^{a} |
| 10 | 323 ± 15^{b} | 47.7 ± 2.29^{b} | 15.9 ± 0.51^{b} |
| 11 | — | — | — |
| 12 | 333 ± 70^{a,b,c} | 40.4 ± 6.91^{b} | 19.5 ± 2.44^{c,d} |
| 13 | 380 ± 78^{b,c} | 27.7 ± 5.56^{a} | 20.0 ± 0.72^{c} |
| 14 | 333 ± 16^{b} | 52.3 ± 2.35^{c} | 16.6 ± 1.37^{b} |
| 15 | 363 ± 23^{c} | 48.4 ± 2.41^{b} | 18.6 ± 0.84^{d} |
| 16 | — | — | — |

Because the thickness of thermoforming pieces varied more than 5%, this could interfere with the mechanical properties. The puncture test results showed similar behavior to the tensile test results. Comparing the samples extruded at 165° C. (Examples 9-10), the samples that have more MTPS (60%) presented lower puncture strength and deformation than samples with 50% MTPS in the sheets and thermoformed pieces. For the samples extruded at 135° C. (Examples 12-15), blends of TPS presented higher puncture strength and lower puncture deformation than MTPS. Comparing the thermoformed blends produced, high amylose corn starch (modified or not; Examples 12 and 14) presented higher puncture strength (N) than samples of regular corn starch (Examples 13 and 15).

Even though the tensile properties of TPS and MTPS blends presented similar numbers, the visual characteristics were very different. The MTPS blends have a more homogenous surface and formed more transparent sheets than the TPS sheets. Another advantage is that MTPS could be blended with other biopolymers with higher melt temperatures, like PLA, without burning. The processability of MTPS of high amylose is much better than the processability of regular corn starch. MTPS of high amylose corn starch (20, 25 or 30% glycerol) can be pelletized, while the MTPS of regular corn starch at the same condition cannot be pelletized. In this case, the materials were collected and ground into a powder before being blended with PBAT.

Thermal Analysis (DSC): Differential scanning calorimetry (DSC) was performed using a high resolution DSC 2920 from TA Instruments. The thermal transitions of the blends and of PBAT were determined. The purge gas, nitrogen, had a flow rate of 50 ml/min. Pellets of the extruded samples were cooled to −50° C. and then heated to 200° C. at a rate of 10° C./min, cooled to −50° C. and then reheated to 200° C.

From the DSC thermograms of the MTPS/PBAT and TPS/PBAT samples (Table 7) a melting temperature for PBAT of 113° C. was observed (Example 16). MTPS and TPS blends presented similar melting temperatures, varying from 115.6° C. to 123.1° C., measured at the second heating (Examples 9-15). The crystallization temperatures were similar for all the MTPS/TPS blends (from 72.4° C. to 79.5° C.), while the PBAT presented a crystallization temperature of 33.0° C. Another endotherm transition was observed for all the blends MTPS and TPS samples close to 0° C., with positive values (from 0.3° C. to 5.1° C.) in the first heating and close to 0° C., with negative numbers (from −6.3° C. to −0.7° C.) in the second heating. This transition is a first order transition (i.e., having a small endotherm peak), that could be related to fusion of the water that could be present in the pellets.

TABLE 8
Differential Scanning Calorimetry of TpS/MTpS Blends with PBAT

| | First | Cooling | | Second Heating | | |
|---|---|---|---|---|---|---|
| | Heating | | ΔHc | | | ΔHm |
| Example | Tg (° C.)? | Tc (° C.) | (J/g) | Tg (° C.) | Tm (° C.) | (J/g) |
| 9 | 3.2 | 78.9 | 6.2 | −0.7 | 123.1 | 6.4 |
| 10 | 5.1 | 79.5 | 7.7 | −1.0 | 123.3 | 6.0 |
| 11 | 0.9 | 72.4 | 8.4 | −6.3 | 115.7 | 6.4 |
| 12 | 1.2 | 75.8 | 6.9 | −2.8 | 117.8 | 6.3 |
| 13 | 3.0 | 74.5 | 9.3 | −4.9 | 116.8 | 7.4 |
| 14 | 2.3 | 79.2 | 7.8 | −2.8 | 121.5 | 6.2 |
| 15 | 0.3 | 72.6 | 8.5 | −4.7 | 121.5 | 6.5 |
| 16 | 2.3 | 33.0 | 20.1 | −2.4 | 113.6 | 16.2 |

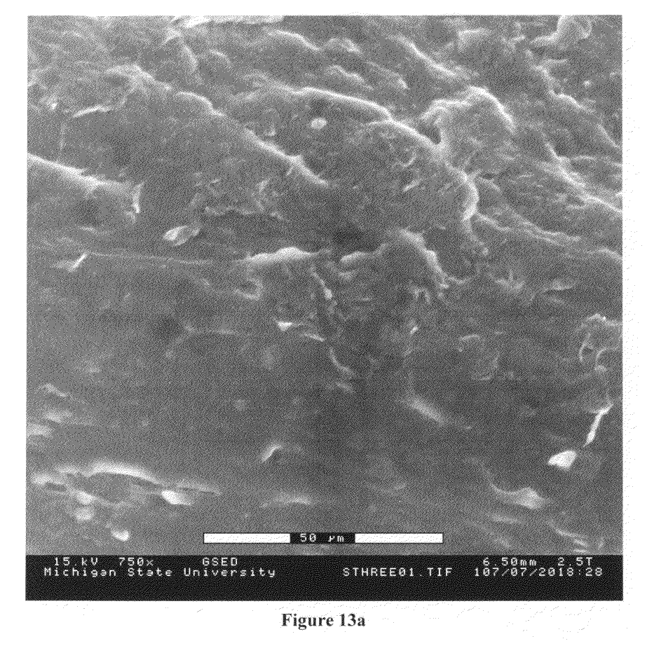

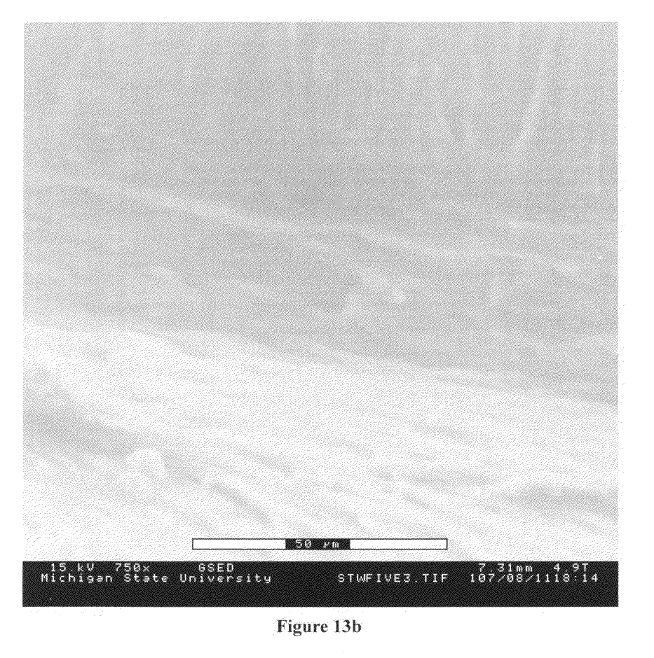

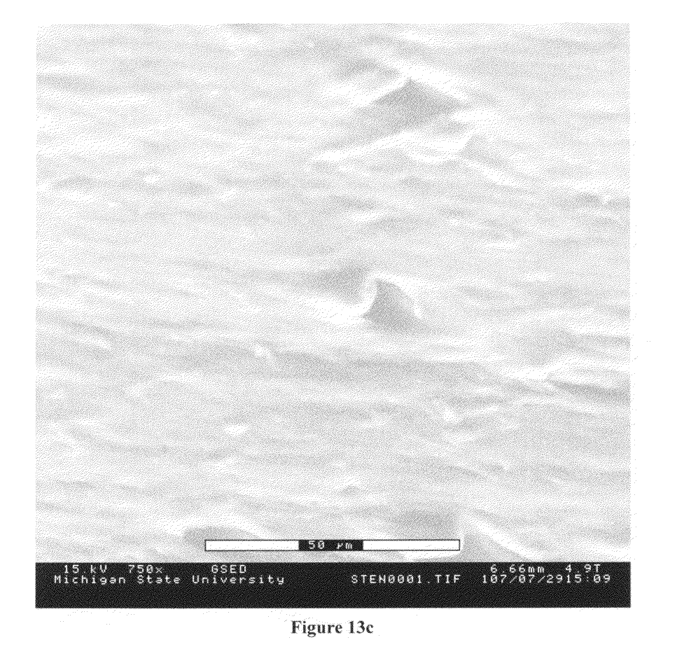

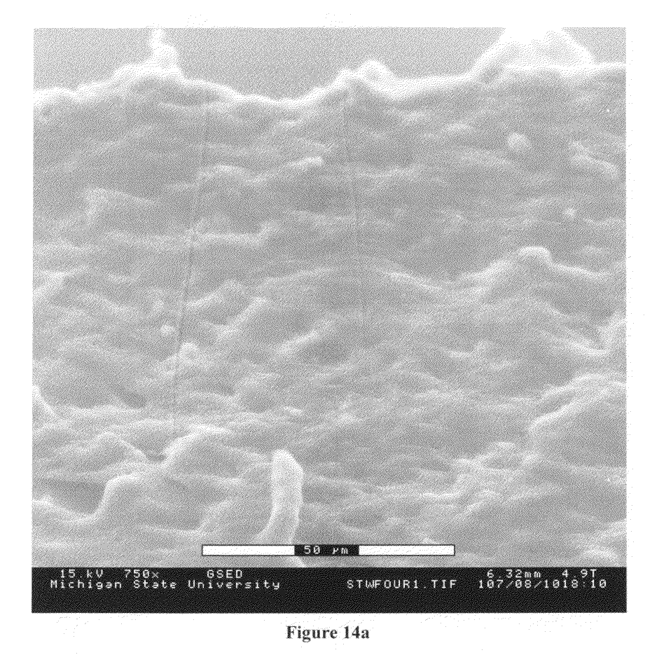

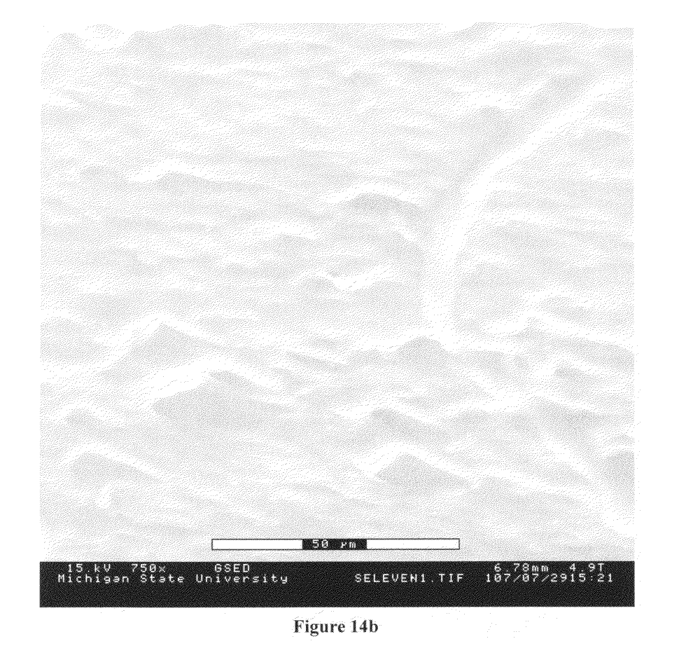

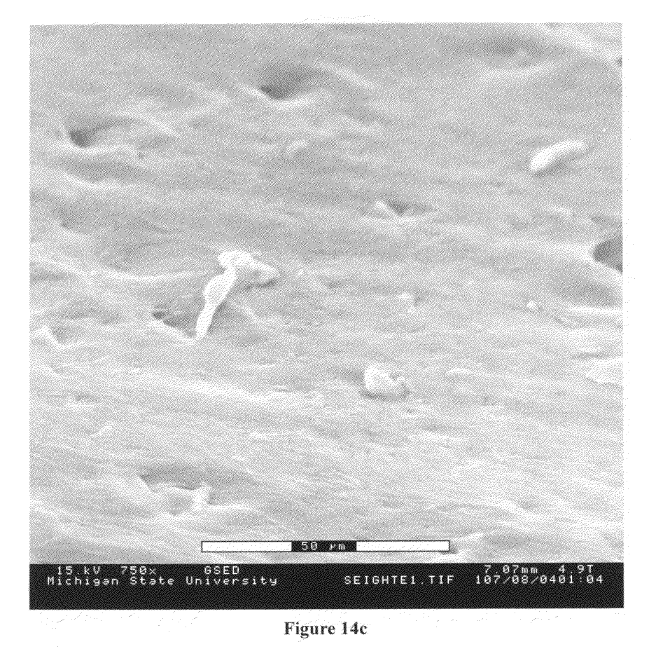

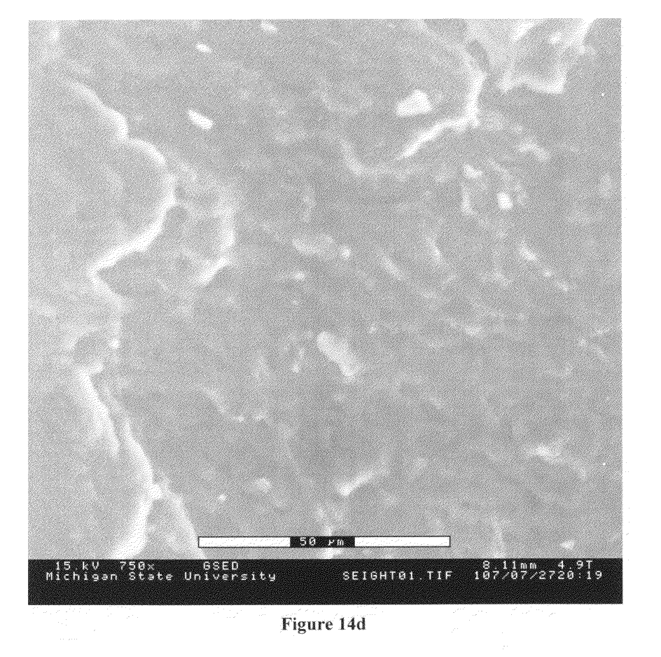

Environmental Scanning Electron Microscopy (ESEM): ESEM observations show the surface of the sheets of blends of MTPS and TPS samples. FIGS. 13a-13c show the samples containing MTPS that were extruded at 165° C. (Examples 9-11, respectively). FIGS. 14a-14d shows the samples containing MTPS and TPS that were extruded with a maximum temperature of 135° C. (Examples 12-15, respectively). In general, the samples that were blended with the thermoplastic starch extruded at 165° C. are more homogeneous and smoother than the samples that were blended with MTPS and TPS samples that were processed at 135° C. This could imply that there was better plasticization of the starch with higher temperatures. According to Mali et al.³¹, a homogeneous matrix of films is a good indicator of their structural integrity and consequently good mechanical properties would be expected. However, better mechanical properties of the samples at 165° C. were not observed. These results could be attributed to the thermoplasticization process. Although the MTPS presented better plasticization, there is also more degradation of starch in the reactive extrusion to produce the MTPS at 165° C.

Summary: Blends of plasticized starch, with or without maleation, with PBAT can form sheets which can be thermoformed. The processability of high amylose corn starch MTPS is much better than the processability of regular corn starch MTPS. The tensile properties are similar for blends of PBAT with TPS and MTPS that have been extruded at a maximum temperature of 135° C. However, the maleated thermoplastic samples formed sheets and thermoformed pieces that were more transparent and had a more homogeneous surface. The effect of amylose content of the different starches used did not present significant differences when the glycerol content was 30% and the ratio of thermoplastic starch/PBAT used was 50:50. When the MTPS contained 20% glycerol and the maximum processing temperature was 165° C., the blend containing MTPS of high amylose corn starch showed better tensile properties than the blend containing MTPS of regular corn starch, when the ratio of thermoplastic starch/PBAT used was 50:50. Increasing the MTPS (high amylose corn starch) content to 60% decreased the tensile strength and elongation of the sheets. The addition of 50% of TPS or MTPS decreased the tensile strength, but did not cause a significant difference in the elongation, compared to the elongation of PBAT.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

Throughout the specification, where the compositions, processes, or apparatus are described as including components, steps, or materials, it is contemplated that the compositions, processes, or apparatus can also comprise, consist essentially of, or consist of, any combination of the recited components or materials, unless described otherwise. Combinations of components are contemplated to include homogeneous and/or heterogeneous mixtures, as would be understood by a person of ordinary skill in the art in view of the foregoing disclosure.

### REFERENCES

1. Tuil R. V., Fowler. P., Lawrher. M., and Weber. C. J., “Properties of biobased packaging materials,” in: Biobased Packaging Materials for the Food Industry—Status and Perspectives, ed. Claus J. Weber, p. 12, November 2000.
2. Kalambur S. and Rizvi S. S. H., “An Overview of Starch-Based Plastic Blends from Reactive Extrusion,” Journal of Plastic Film & Sheeting, vol. 22, January, 2006.
3. Averous L., Fringant C., and Moro L., “Starch-based Biodegradable Materials Suitable for Thermoforming Packaging,” Starch/Starke, 53: 368-371 (2001)
4. Zobel H. F., “Molecular to Granules: a comprehensive starch review,” Starch/Starke, 40(2): 44-50 (1988)
5. Van Soest. J. J. G., Starch plastics structure-property relationships, Ultrecht University (Netherlands), P&L Press, Wageningen (1999)
6. Wiedmann W. and Strobel E., Starch, 43: 138 (1991)
7. Shorgen R. L., Fanta G. F., and Doan W. M., Starch, 45: 276 (1993)
8. Forssell P., Mikkila J., and Sourtti T., J.M.S. Pure Appl. Chem., A33: 703 (1996)
9. Narayan R., Polymers from Agricultural Co products, ACS Symp Ser. (1994)
10. Van Soest J. J. G., Benes K., and de. Wit D., Polymer, 37: 3543 (1996)
11. Fanta G. F. and Bagley E. B., Encyclopedia of Polymer Science, John Wiley & Sons, New York (1970)
12. Fanta G. F., Block and Graft Copolymers—Vol I, John Wiley & Sons, New York (1973)
13. Otey F. H., Westhoff R. P., and Doane W. M., Industrial Engineering Chemistry Products Research Development, 19: 592 (1980)
14. Otey F. H. and Westhoff R. P, Industrial Engineering Chemistry Products Research Development, 23: 284 (1984)
15. Otey F. H., Westhoff R. P., and Doane W. M., Industrial Engineering Chemistry Products Research Development, 26: 1659 (1987)
16. Vaidya U. R. and Bhattacharya M., Journal of Applied Polymer Science, 52: 617 (1994)
17. Bhattacharya M., Vaidya U. R., Zhang D., and Narayan. R., Journal of Applied Polymer Science, 57: 539 (1995)
18. Mani R. and Bhattacharya M., European Polymer Journal, 34: 1467 (1998)
19. Carlson. D. L., Nie. L., Narayan. R., Dubois. P., Journal of Applied Polymer Science, 72: 477 (1999)
20. Wu. C-S., “Physical properties and biodegradability of maleated-polycaprolactone/starch composite,” Polymer Degradation and Stability, 80: 127-134 (2003)
21. Nabar Y., Raquez J. M., Dubois P., Narayan R., “Production of starch foams by twin-screw extrusion: Effect of maleated poly(butylene adipate-co-terephthalate) as a compatibilizer,” Biomacromolecules, 6: 807-817 (2005)
22. Dubois P. and Narayan R., “Biodegradable Compositions by Reactive Processing of Apliphatic Polyester/Polysaccharide Blends,” Macromolecular Symposia, 198: 233-243 (2003)
23. Huneault M. A. and Li H, “Morphology and Properties of compatibilized polylactide/thermoplastic starch blends,” Polymer, 48: 270-280 (2007)
24. Chandra R. and Rustgi R., “Biodegradation of maleated linear low-density polyethylene and starch blends,” Polymer Degradation and Stability, 56: 185-202 (1997)
25. Shujun W., Jiugao Y., and Jinglin Y., “Preparation and characterization of compatible thermoplastic starch/polyethylene blends,” Polymer Degradation and Stability, 87: 395-401 (2005)
26. Rindlav-Westling A., Stading M., Hermansson A. M., & Gatenholm P., “Structure, mechanical and barrier properties of amylose and amylopectin films,” Carbohydrate Polymers, 36: 217-224 (1998)
27. Lourdin D., Della Valle G., Colonna P., “Influence of amylose content on starch films and foams,” Carbohydrate Polymers, 27: 275-280 (1995)
28. Tharanathan R. N., “Biodegradable films and composite coatings: past. present and future,” Trends in Food Science and Technolology, 14: 71-78 (2003)
29. Alves V. D., Mali S., Grossmann M. V., and Beleia A., “Effect of glycerol and amylose enrichment on cassava starch film properties,” Journal of Food Engineering, 78(3): 941-946 (2007)
30. Myllärinen P., Partanem R., Sppälä J., and Forssell P., “Effect of glycerol on behaviour of amylose and amylopectin films,” Carbohydrate Polymers, 50: 355-361 (2002)
31. Mali S., Grossmann M. V. E., Garcia M. A., Martino M. M., and Zaritzky N. E., “Microstructural characterization of yam starch films,” Carbohydrate Polymers, 50: 379-386 (2002)

What is claimed is:

1. A starch-polyester graft copolymer composition comprising:
(a) a thermoplastic starch, the thermoplastic starch comprising a high-amylose starch and a plasticizer, and
(b) segments of a biodegradable polyester grafted onto the thermoplastic starch.

2. The starch-polyester graft copolymer composition of claim 1, wherein the graft copolymer comprises a reactively extruded a mixture of the thermoplastic starch and the biodegradable polyester with heating and venting of water from the mixture.

3. The starch-polyester graft copolymer composition of claim 1, wherein the high-amylose starch comprises one or more of corn, potato, wheat, rice, sago, tapioca, waxy maize, sorghum, and cassava starch.

4. The starch-polyester graft copolymer composition of claim 1, wherein the high-amylose starch has an amylose content of at least about 40 wt. %.

5. The starch-polyester graft copolymer composition of claim 1, wherein the plasticizer comprises a polyhydric alcohol.

6. The starch-polyester graft copolymer composition of claim 1, wherein the thermoplastic starch comprises a modified thermoplastic starch, the modified thermoplastic starch comprising a reactively blended mixture of the starch, the plasticizer, a chemical modifier comprising one or more dibasic acids, cyclic anhydrides thereof, or combinations thereof, and an optional free radical initiator.

7. The starch-polyester graft copolymer composition of claim 6, wherein the chemical modifier comprises one or more of maleic acid, succinic acid, itaconic acid, phthalic acid, and anhydrides thereof.

8. The starch-polyester graft copolymer composition of claim 6, wherein the reactively blended mixture comprises the free radical initiator.

9. The starch-polyester graft copolymer composition of claim 1, wherein the biodegradable polyester comprises one or more biodegradable aliphatic polyesters, biodegradable aliphatic-aromatic polyesters, and poly(β-hydroxyalkanoates).

10. The starch-polyester graft copolymer composition of claim 1, wherein the biodegradable polyester comprises one or more repeating units according to Formulas I-III: 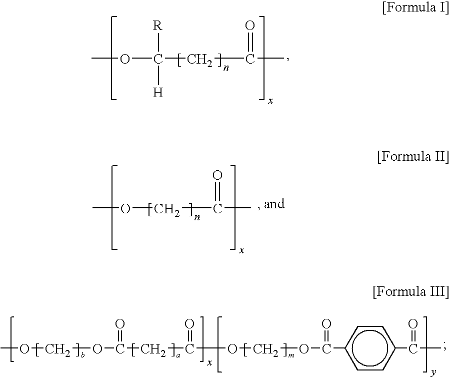
wherein:
(i) in Formula I, R comprises one or more lower alkyl and aromatic groups containing 1 to 12 carbon atoms, and n ranges from 0 to 10;
(ii) in Formula II, n ranges from 0 to 10; and
(iii) in Formula III, a, b and m range from 2 to 8, and x/y ranges from about 3/2 to 10/1.

11. The starch-polyester graft copolymer composition of claim 1, wherein the graft copolymer is completely biodegradable.

12. A starch-polyester graft copolymer composition comprising:
(a) a modified thermoplastic starch, the modified thermoplastic starch comprising a reactively blended mixture of a high-amylose starch, a polyhydric alcohol plasticizer, a chemical modifier comprising one or more dibasic acids, cyclic anhydrides thereof, or combinations thereof, and an optional free radical initiator; and
(b) segments of a biodegradable aliphatic-aromatic polyester grafted onto the modified thermoplastic starch.

13. The starch-polyester graft copolymer composition of claim 12, wherein:
the thermoplastic starch comprises about 65 wt. % to about 85 wt. % of the high-amylose starch and about 20 wt. % to about 40 wt. % of the polyhydric alcohol plasticizer, both relative to the thermoplastic starch weight; and
the starch-polyester graft copolymer comprises about 40 wt. % to about 70 wt. % of the thermoplastic starch and about 30 wt. % to about 60 wt. % of biodegradable aliphatic-aromatic polyester, both relative to the starch-polyester graft copolymer weight.

14. The starch-polyester graft copolymer composition of claim 12, wherein:
the high-amylose starch comprises a corn starch having an amylose content of at least about 65 wt. %;
the chemical modifier comprises one or more of maleic acid and maleic anhydride;
the polyhydric alcohol plasticizer comprises glycerol; and
the reactively blended mixture comprises the free radical initiator.

15. The starch-polyester graft copolymer composition of claim 12, wherein the biodegradable aliphatic-aromatic polyester comprises repeating units according to Formula III: 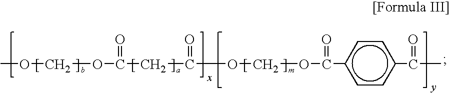
wherein a, b and m range from 2 to 8, and x/y ranges from about 3/2 to 10/1.

16. A process for the preparation of a starch-polyester graft copolymer thermoformed article, the process comprising:
melt extruding a mixture of (a) a thermoplastic starch, the thermoplastic starch comprising a starch and a plasticizer and (b) a biodegradable polyester at a temperature that grafts segments of the biodegradable polyester onto the thermoplastic starch, thereby forming a starch-polyester graft copolymer sheet; and
thermoforming the starch-polyester graft copolymer sheet, thereby forming a thermoformed article.

17. The process of claim 16, further comprising heating and venting water while melt extruding the mixture.

18. The process of claim 16, wherein the thermoformed article is selected from the group consisting of cups, containers, lids, and trays.

19. The process of claim 16, wherein the starch-polyester graft copolymer sheet has a thickness ranging from about 0.1 mm to about 5 mm.

20. The process of claim 16, wherein the starch comprises one or more of corn, potato, wheat, rice, sago, tapioca, waxy maize, sorghum, and cassava starch.

21. The process of claim 16, wherein the starch comprises a high-amylose starch having an amylose content ranging from about 50 wt. % to about 95 wt. %.

22. The process of claim 16, wherein the plasticizer comprises a polyhydric alcohol.

23. The process of claim 16, wherein the thermoplastic starch comprises a modified thermoplastic starch, the modified thermoplastic starch being formed by reactively blending a mixture of the starch, the plasticizer, a chemical modifier comprising one or more dibasic acids, cyclic anhydrides thereof, or combinations thereof, and an optional free radical initiator.

24. The process of claim 23, wherein the chemical modifier comprises one or more of maleic acid, succinic acid, itaconic acid, phthalic acid, and anhydrides thereof.

25. The process of claim 23, wherein the reactively blended mixture comprises the free radical initiator.

26. The process of claim 23, comprising performing the reactive blending at a temperature ranging from about 90° C. to about 180° C.

27. The process of claim 16, wherein the biodegradable polyester comprises one or more biodegradable aliphatic polyesters, biodegradable aliphatic-aromatic polyesters, and poly(β-hydroxyalkanoates).

28. The process of claim 16, wherein the biodegradable polyester comprises one or more repeating units according to Formulas I-III: 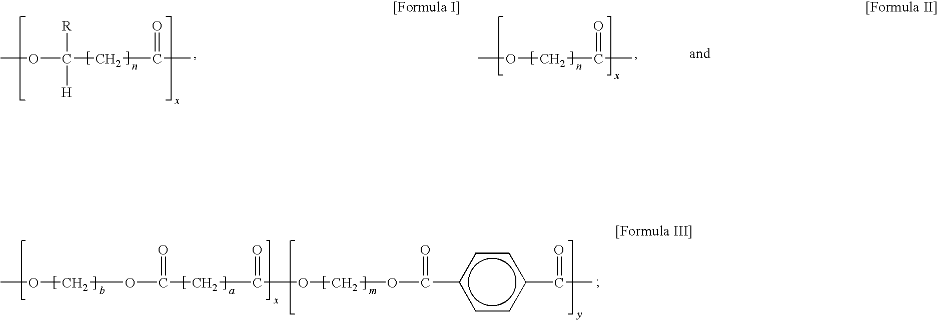
wherein:
(i) in Formula I, R comprises one or more lower alkyl and aromatic groups containing 1 to 12 carbon atoms, and n ranges from 0 to 10;
(ii) in Formula II, n ranges from 0 to 10; and
(iii) in Formula III, a, b and m range from 2 to 8, and x/y ranges from about 3/2 to 10/1.
